(19) United States
(12) Patent Application Publication
(10) Pub. No.: US 2022/0212202 A1
(43) Pub. Date: Jul. 7, 2022

(54) METHOD AND APPARATUS FOR FILTRATION

(71) Applicant: Paul Neiser, Mountain View, CA (US)

(72) Inventor: Paul Neiser, Mountain View, CA (US)

(21) Appl. No.: 16/701,091

(22) Filed: Dec. 2, 2019

Related U.S. Application Data
(60) Provisional application No. 62/917,379, filed on Dec. 3, 2018.

(51) Int. Cl. B03C 3/02; B03C 1/02; B03C 3/70; B03C 5/02; B01D 53/22; B01D 45/02; B01D 45/04; B03C 3/15; B03C 3/36

(52) U.S. Cl. CPC B03C 3/025; B03C 1/02; B03C 3/70; B03C 5/02; F02K 7/10; B01D 45/02; B01D 45/04; B03C 3/15; B03C 3/368; B01D 53/22

(57) ABSTRACT

A filtering apparatus with a Body Force Generating Apparatus (BFGA) facilitates diffusion of objects of interest from a first reservoir to a second reservoir. The BFGA applies a body force per unit mass on objects of interest, such as air molecules, water molecules, dust particles, ions, electrons, and other types of elementary particles or constituent parts within a medium. The force field generated by the BFGA gives rise to a spatially varying potential field having a spatial or temporal gradient that is sufficiently strong at at least one location in space or instant in time such that objects of interest experience a departure from normal statistical behavior within that field. This can be employed to increase the pressure of objects of interest in a second reservoir relative to a first reservoir. A pressure modification apparatus and method can convert thermal energy into useful energy, such as mechanical work or electricity.

### CROSS REFERENCE TO RELATED APPLICATIONS

This application claims the benefit under 35 U.S.C. § 119 from U.S. Provisional Patent Application Ser. No. 62/917,379, entitled “Method And Apparatus For Filtration,” filed on Dec. 3, 2018, the subject matter of which is incorporated herein by reference.

### TECHNICAL FIELD

The described embodiments relate to filtering, pumping, and/or concentrating objects of interest.

### BACKGROUND INFORMATION

Filtering, pumping or changing the concentration of objects of interest typically consumes useful energy. For example, in a typical desalination plant employing reverse osmosis, the separation of the solute from the solution consumes useful power in the form of electricity. Similarly, the pumping of fluid by a conventional aircraft engine during the production of thrust consumes useful energy provided separately in the form of hydrocarbon fuel or in the form of an electrical battery, for example.

### SUMMARY

Methods of facilitating the diffusion of objects of interest from a first reservoir to a second reservoir, comprise providing a filtering apparatus comprising a Body Force Generating Apparatus (BFGA). The BFGA is configured to apply a body force per unit mass on objects of interest, such as air molecules, water molecules, dust particles, ions, electrons, and other types of elementary particles or constituent parts within a medium. The force field generated by the BFGA gives rise to a spatially varying potential energy of objects of interest, i.e. a spatially varying potential field. The BFGA is configured in a manner in which the spatial or temporal gradient of the potential field is sufficiently strong at at least one location in space or at least one instant in time, that the objects of interest experience a departure from normal statistical behavior within that field. Normal statistical behavior can refer to the behavior described by the Maxwell-Boltzmann statistics, Fermi-Dirac statistics, or Bose-Einstein statistics. For example, the potential gradient can be larger than the ratio of 0.1% of the average energy of an object of interest over the length of 1000 mean free paths, or 1000 mean free times of an object of interest adjacent to the potential gradient.

When the aforementioned sufficiently steep potential gradient is combined with a potential gradient with a different steepness, or different gradient magnitude, in asymmetric fashion, a net diffusion of objects of interest can be accomplished in a dynamic boundary condition, or a difference in concentration can be achieved in a static boundary condition. The body force can be inertial, gravitational, magnetic, electric, or electromagnetic in nature, for example. The body force can also be a perceived or generic body force due to drag, for instance, leading to a generic potential energy.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A is a cross-sectional view of an exemplary embodiment of the invention.

FIG. 1B is a schematic plot of several physical properties as a function of position for the exemplary embodiment shown in FIG. 1A.

FIG. 2 is a plot of several physical properties as a function of a change in the depth of a potential well for an exemplary embodiment of the invention.

FIG. 3A is a cross-sectional view of an exemplary embodiment of the invention.

FIG. 3B is a schematic plot of several physical properties as a function of position for the exemplary embodiment shown in FIG. 3A.

FIG. 4A is a cross-sectional view of an exemplary embodiment of the invention.

FIG. 4B is a schematic plot of several physical properties as a function of position for the exemplary embodiment shown in FIG. 4A.

FIG. 5A is a cross-sectional view of an exemplary embodiment of the invention.

FIG. 5B is a schematic plot of several physical properties as a function of position for the exemplary embodiment shown in FIG. 5A.

FIG. 6A is a cross-sectional view of an exemplary embodiment of the invention.

FIG. 6B is a schematic plot of several physical properties as a function of position for the exemplary embodiment shown in FIG. 6A.

FIG. 7 is a cross-sectional view of an application of an embodiment of the invention in a supersonic ramjet engine.

FIG. 8 is a cross-sectional view of the example embodiment of FIG. 7 in a closed configuration.

FIG. 9 is a plot of the value of pressure versus specific volume of air which passes through an example embodiment of the invention.

FIG. 10 is a plot of the value of pressure versus specific volume of air which passes through another example embodiment of the invention.

FIG. 11 is a diagram that shows another embodiment of a filtering apparatus 3400 in accordance with various embodiments.

### DETAILED DESCRIPTION

Reference will now be made in detail to some exemplary embodiments of the invention, examples of which are illustrated in the accompanying drawings.

The term “medium” used herein describes any material which is capable of containing, carrying, transporting, or transferring an object of interest. A medium can be a gas, liquid, solid, or vacuum, for example. By default, a medium refers to the collection of all objects which interact with a specified apparatus.

The term “object” used herein describes any component of a medium. An object can be described as a particle, such as a dust particle, a soot particle, a water droplet, or a water molecule. Other examples of objects are subatomic particles such as electrons or protons. An object can also be described as a wave, such as a photon, phonon, or an ocean wave. An object can also be a virtual object, such as a virtual photon, virtual electron or virtual positron, as described by quantum mechanics. An object can have a property of interest, as well as a defining property, which can be used to distinguish an object from other objects of the medium. Embodiments of the invention apply to any medium which can be considered to comprise distinct objects.

One can define a “dynamic boundary condition” as a simplified scenario in which the properties of the medium at a first reservoir and a second reservoir are identical and uniform in time and space. For example, the density of OI in the first reservoir and the second reservoir can be identical for the dynamic boundary condition, where the density is measured at a very large distance from an embodiment of the invention, such that the embodiment does not affect the measurement.

One can define a “static boundary condition” as a simplified scenario in which a first and second reservoir are finite in size and isolated from each other and any other reservoirs apart from an embodiment of the invention allowing the exchange of OI between the first and second reservoirs. In the static boundary condition, the macroscopic properties of interest of the medium in the first and second reservoirs have reached a steady state value, where the steady state value is substantially constant in time and space, i.e. substantially uniform throughout a reservoir. Such macroscopic properties can refer to the pressure, temperature, or density of a medium, for example. For example, the density of OI can be substantially uniform or constant throughout a first and second reservoir, which also applies to the portions of the reservoirs in proximity of embodiments of the invention. The value of the average density in the first and second reservoir need not be identical for the static boundary condition.

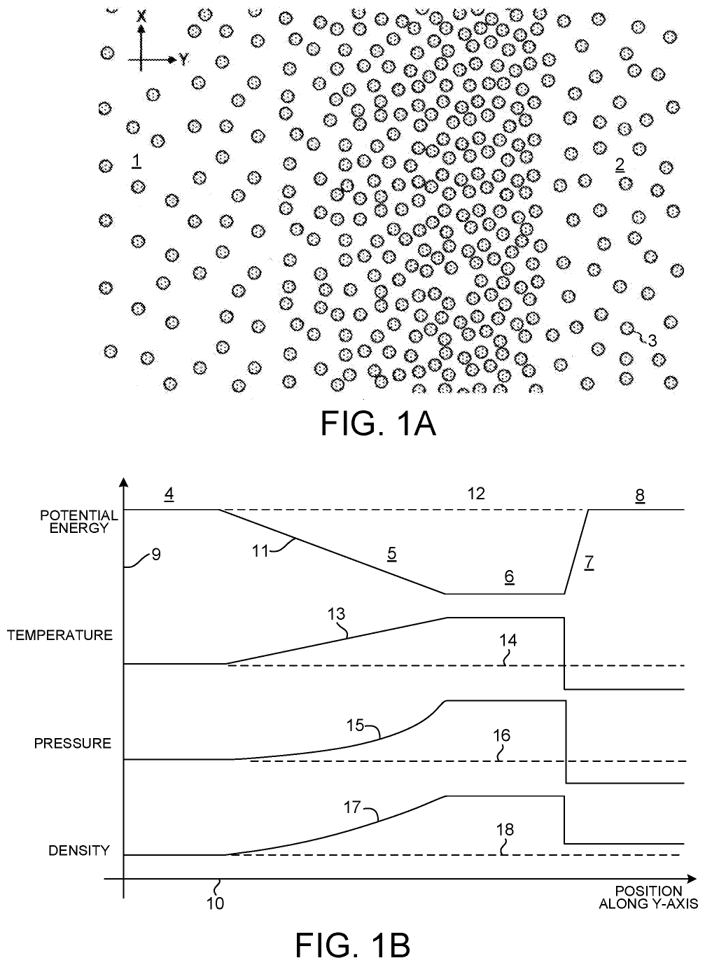

FIG. 1A is a cross-sectional view of an exemplary embodiment of the invention.

In the first reservoir 1 and the second reservoir 2, the medium comprises objects of interest, or “OI”, which are schematically represented by individual particles, such as the schematic representation of particle 3. For simplicity, the medium can be considered to be an ideal gas comprising monatomic molecules. In other embodiments the medium can consist of other types of objects, such as water molecules. In any one reservoir or chamber, the medium can also comprise several different types of objects, such as sodium and chlorine ions found in salt water.

In this embodiment, a force generating apparatus is configured to apply a force on the OI. In FIG. 1A the force generating apparatus is not shown for simplicity in FIG. 1A.

There are a large number of different ways in which a force can be applied to OI. The force can be applied to the OI in the form of a body force per unit mass, or an acceleration, acting on individual OI.

One type of such a body force per unit mass is the gravitational acceleration acting on a medium.

A body force can arise from the existence of a potential field gradient. One such example is the force which arises from the gradient of an electric potential. For example, the elements of a medium can be configured to be electrically charged. In the context of a medium, the term “elements” refers to the constituent parts of the medium, such as sub-molecular particles, molecules, or a distinct or specified collection of molecules, for example. In the case of a gas, the molecules could be positively or negatively ionized, for instance. The medium can also comprise a collection of mobile electrons. Note that this collection can be contained in a solid, such as a conductor, or it can be described as a gas. By applying an electric field within a reservoir, body forces per unit mass can be generated on the electrically charged elements of the medium inside the reservoir.

For other embodiments it can be impossible or inconvenient to use, procure, or create a medium with mobile electrical charges. In this case, elements of the medium can be polarized by applying an electric field, or these elements can already have an intrinsic polarization, as in the case of polar molecules, such as water. When placed in an electric field gradient, these polarized elements can experience a body force. Note that the magnitude of said force depends on the orientation of the polarization axis relative to the electric field, amongst other parameters. Thus an electric field can be configured to generate body forces per unit mass on the polar elements in the medium in a reservoir, as well as polarize elements in the medium, if necessary. The electric field can be applied in a myriad of ways known in the art.

Magnetism can also be employed to generate body forces. The medium can comprise diamagnetic, paramagnetic, or ferromagnetic elements. When magnetized, the individual elements in the medium can form magnetic dipoles, or these elements can already have an intrinsic magnetic dipole, such as an electron. When these magnetic dipoles are placed in a magnetic field with a non-zero curl or gradient, they can experience a body force. Note that the magnitude of the body force is a function of the orientation of the magnetic dipole relative to the local magnetic field, amongst other parameters. Thus an external magnetic field can be configured to generate body forces per unit mass on the magnetized elements in the medium in a reservoir, as well as magnetize the elements in the medium, if necessary. The magnetic field can be generated by ferromagnets other at least instantaneously magnetized elements, or by an electrical current flowing through an electromagnet, amongst other methods known in the art.

The body forces per unit mass can also arise from inertial effects. For instance, a reservoir can be subject to an acceleration in an inertial frame. This results an acceleration of the medium relative to the reservoir. Inertial forces can be generated by linear acceleration, i.e. motion of the reservoir along a straight line in the inertial frame. Inertial forces can also be generated by angular acceleration, i.e. motion of the reservoir along a curved path. In general, inertial forces can be generated by any accelerating motion in an inertial frame. Embodiments employing other types of forces or combinations thereof are within the spirit and scope of the invention.

In some embodiments, the force can also be applied to the OI mechanically, e.g. by thrust generating apparatuses, such as wings, airfoils, propellers, turbomachinery, such as a centrifugal or an axial compressor, nozzles, or ducts, for example. In such apparatuses, there need not be a bulk flow of the medium containing the OI, such as during the static boundary condition. In other words, an axial compressor can be configured to compress the medium without bulk flow of the medium in an axial direction.

In both cases, i.e. in the case in which the force acting on the medium is a body force per unit mass and in the case in which the force acting on the medium is applied mechanically by turbomachinery, one can define a potential as the integral of the value of the average force acting on an OI over a displacement relative to a specified reference point. Note that the potential in this context is a mathematical construct, and need not have a physical manifestation. Therefore, the term “potential” used herein can also be referred to as a pseudo-potential in order to differentiate the potential described herein from the conventional, conservative potentials, such as the electric or gravitational potentials. One can define the position within any thermal reservoir which is subject to an average force in terms of the value of a potential at that position. For a given potential, there is a set of possible points within the reservoir at which the value of the potential is the value of the given potential. In general, this set describes a three dimensional equipotential surface.

A force acting on a medium is provided by a force generating apparatus. If the force is a mechanical force, the force generating apparatus can be an axial compressor, for example. If the force is a body fore per unit mass, the force generating apparatus can be an electric field generating apparatus, for example. The force acting on the medium can be considered to give rise to an associated generic potential energy of individual OI. In the scenario in which the force acting on the medium is provided mechanically the change of “generic potential energy”, as used herein, between a specified first and second point in space or time is the average value of the integral of the force acting on an OI while the OI moves from a first specified point to a second specified point, where the average is calculated along all possible paths that can be taken by all possible OI of all possible initial energies between the specified points. The generic potential energy is a consequence of individual OI experiencing a specified force along a specified path moving between two specified points in space.

In a simplified example, consider an OI moving freely against a body force per unit mass. This OI will experience a reduction of its average kinetic energy and a corresponding increase in its average generic potential energy, where the average can be calculated over a specified volume or reservoir containing OI, for instance. Free motion refers to an OI interacting only weakly with other OI, or not interacting with other OI at all. For example, an air molecule can be considered to move freely between collisions with other air molecules. An air molecule interacting with the gravitational field during said free motion can experience a change in its generic potential energy and kinetic energy. In this example, the generic potential energy can be considered to be identical to the conventional potential energy.

In another example, an OI diffusing upstream, i.e. in the opposite direction of the force applied by the axial turbine on the medium containing OI, through a conventional axial turbine subject to a static boundary condition will on average be decelerated by a certain amount, i.e. experience an average reduction in average kinetic energy as a result of interacting with the turbine. The compressor is configured to increase the pressure in a first reservoir located at one end of the compressor relative to the pressure in a second reservoir located at the other end of the compressor in the case in which there is no net bulk flow of the medium containing OI between the first point and the second point, through the compressor. In this hypothetical scenario, the axial turbine is assumed to be frictionless, i.e. is assumed to not heat the medium containing OI due to friction associated with the relative motion between the turbine blades and the medium containing OI, for simplicity. Alternatively, the rate of heat delivered to the medium containing OI by the axial turbine via friction can be balanced by an equal rate of heat removed from the medium during nominal operations, where the heat removal can be via thermal conduction, for example. The aforementioned reduction in the average kinetic energy is associated with a corresponding increase in generic potential energy of the OI. Note that, such a process is typically not associated with an increase in conventional potential energy of the OI, but rather an exchange of energy between the OI and the environment. Thus, a change in generic potential energy, as used herein, can refer to a conservative or a non-conservative process. Note that there are different types of generic potential energy, such as gravitational, electric, or mechanical generic potential energy, for example. As used herein, the generic potential energy typically refers to the generic potential energy associated with a particular set of force generating apparatuses, which is either specified, or clear from context.

In FIG. 1B, the vertical axis 9 indicates the value of a specified physical property, and the horizontal axis 10 indicates the position along the Y-axis at which said physical property is measured.

In FIG. 1B the value of the average generic potential energy of an OI at the specified position along the Y-direction is indicated by line 11. In this particular exemplary embodiment, the generic potential energy of individual OI within the first reservoir 1 is constant in space and time, as indicated by constant region 4. The generic potential energy within the second reservoir 2 is also constant in space and time, as indicated by constant region 8. The potential energy of an individual OI in the first reservoir 1 and the second reservoir 2 is identical in this simplified example, The horizontal dashed line 12 indicates the value of the generic potential energy in the first reservoir 1 for reference. As mentioned, the generic potential energy 11 is the generic potential energy associated with the force generating apparatus which applies a force on the OI. In other embodiments, the generic potential energy 11 in the first reservoir 1 can be larger or smaller than the generic potential energy in the second reservoir 2.

An OI diffusing from the first reservoir 1 to the second reservoir 2 will first encounter a gradually decreasing generic potential energy 11 in a first transition region 5. In the depicted embodiment, the gradual change 5 in generic potential energy is linear. In other embodiments, the generic potential energy 11 can decrease at an increasing rate or at a decreasing rate in the first transition region 5. Subsequently to the first transition region 5, an OI diffusing from the first reservoir 1 to the second reservoir 2 will encounter a constant region 6. In other embodiments, there need not be a region 6 in which the generic potential energy is substantially constant. Subsequently to the constant region 6, an OI diffusing from the first reservoir 1 to the second reservoir 2 will encounter a second transition region 7. In the depicted embodiment, the gradual change 7 in generic potential energy is linear. In other embodiments, the generic potential energy 11 can increase at an increasing rate or at a decreasing rate in the second transition region 7. The rate of change of the generic potential 11 in the second transition region 7 along the Y-direction is larger in magnitude and opposite in sign relative to the rate of change of the generic potential 11 in the first transition region 5. The efficacy of the embodiment in FIG. 1A can be increased by increasing the magnitude of the rate of change of the generic potential 11 in the second transition region 7 along the Y-direction. In FIG. 1A, the extent of the second transition region 7 along the Y-axis is on the order of the mean free path of OI in the constant region 6, i.e. between the first transition region 5 and the second transition region 7. As a result, the compression of the medium comprising OI in the second transition region 7 cannot be considered to correspond to the adiabatic compression of an ideal gas. In FIG. 1A, the extent of the first transition region 5 along the Y-axis is much larger than the extent of the second transition region 7 along the Y-axis, such that the compression of the medium comprising OI in the first transition region 5 can be modeled as a conventional, adiabatic compression of an ideal gas. In other embodiments, this need not be the case, as long as the magnitude of the gradient of the generic potential energy of an OI due to the force generating apparatus is smaller in the first transition region 5 than the second transition region 7, and provided that other relevant conditions, obvious to those skilled in the art, are met. In FIG. 1A, the change in the generic potential energy of OI throughout the first transition region 5, or the second transition region 7, is on the order of the average energy of an OI in the first reservoir. In general, the number of collisions of an OI per unit change in generic potential energy is larger in the first transition region 5 than in the second transition region 7. The collisions can be between the OI and other OI, other objects, or surfaces, where the collisions are configured to be able to change the velocity component of an OI along the Y-direction. A “collision”, as used herein, refers to an event which is capable of changing the kinetic energy of an OI along the instantaneous line of action along which the force of the force generating apparatus, which is responsible for the generic potential energy, is acting. As a result, the behavior of OI diffusing in the positive or negative Y-direction through the second transition region 7 can be described to a lesser extent as an adiabatic expansion or compression of an ideal monatomic gas than the behavior of an OI diffusing in the negative or positive Y-direction through the first transition region 5. As a result, the thermodynamic properties of the medium containing OI in the second reservoir 2 can be different than the thermodynamic properties of the medium containing OI in the first reservoir 1. The same principle can be applied to other types of media, such as other ideal gases, real gases, or electrons within conductors. A difference in the magnitude of the spatial or temporal gradient of the generic potential energy of OI within a medium for a first change of the generic potential energy experienced by OI within a medium compared to a second change of the generic potential energy in a direction opposite to the first change can be employed to change the thermodynamic properties of an medium compared to a reference scenario in which the magnitude of the spatial or temporal gradient is identical for the first change and the second change.

Note that, when the extent of the second transition region 7 along the Y-axis is smaller than the extent of the first transition region 5 along the Y-axis, but several orders of magnitude larger than the smallest mean free path of OI within the second transition region 7, the difference in the thermodynamic properties of the medium in the second reservoir 2 compared to the first reservoir 1 for a static boundary condition can be very small.

Note that, in other embodiments, the behavior of OI through any transition region, such as first transition region 5 or a second transition region 7, need not be adiabatic. For example, heat can be exchanged with the environment throughout a transition region. In some embodiments, the behavior of an OI through a transition region can be isothermal, for example. The OI can also experience an isobaric compression when diffusing in the positive Y-direction through a first transition region, similar to first transition region 5, for instance. In some embodiments, mass can also be exchanged with the environment throughout a transition region.

The principle of operation of the exemplary, simplified embodiment shown in FIG. 1A and FIG. 1B will be described in detail in the following paragraphs.

In FIG. 1A, the first transition region 5 is modeled as an adiabatic compression of an ideal monatomic gas comprising OI for simplicity. Accordingly, the temperature 13 increases linearly between the first reservoir 1 and the constant region 6. As mentioned, in other embodiments, the compression of the medium comprising OI need not be adiabatic, and the compression need not follow an ideal gas law. The horizontal dashed line 14 indicates the value of the temperature of the medium consisting of OI in the first reservoir for reference. The pressure 15 increases adiabatically in the first transition region 5. The horizontal dashed line 16 indicates the value of the pressure of the medium consisting of OI in the first reservoir for reference. The density 17 increases adiabatically in the first transition region 5. The horizontal dashed line 18 indicates the value of the pressure of the medium consisting of OI in the first reservoir for reference. Note that, in the static boundary condition, OI can diffuse in the positive and negative Y-direction through the first transition region 5.

In FIG. 1A, the gradient of the generic potential energy in the second transition region 7 is finite. In other embodiments, the gradient of the generic potential energy can be so large that it can be considered to be infinite. This simplifies the mathematical model of the second transition region 7. For illustrative purposes, consider the following simplified model. For a static boundary condition, the behavior of the OI in the majority of the constant region 6 and the second reservoir 2, i.e. constant region 8, is described by Maxwell-Boltzmann distribution. In other words, the medium containing OI in the constant region 6 and constant region 8 can be modeled as a stationary monatomic ideal gas in thermal equilibrium in this simplified example. The temperature, density, and pressure of the medium in constant region 6 is larger than the temperature, density, and pressure in constant region 4, where the increase is described by the aforementioned adiabatic compression of the ideal gas by the force generating apparatus which reduces the generic potential energy 11 in the first transition region 5.

Consider an OI moving freely from the constant region 6 through the second transition region 7 to constant region 8. This OI will experience a reduction in its velocity along the Y-direction due to the increase in the generic potential energy. The velocities of the OI along the X- and Z-direction are unchanged during this free motion. Free motion refers to the motion of an OI between collisions with other OI in the context of FIG. 1A. The free motion of an OI from the constant region 6 through the second transition region 7 to the constant region 8, i.e. without colliding with other OI, can be referred to as a direct transmission. Note that, in order for an OI to move freely from the constant region 6 through the second transition region 7 to constant region 8, the velocity of the OI along the Y-direction must be large enough for the OI to surmount the increase in the generic potential energy, i.e. to overcome the force applied by the force generating apparatus in the negative Y-direction throughout the second transition region 7.

Consider a test OI diffusing from the constant region 6 into the second transition region 7, where the test OI does not have a large enough velocity component along the Y-direction to overcome the increase in the generic potential in the second transition region 7. If the test OI does not collide with any other OI in the second transition region 7, the OI will return to the constant region 6. This process can be referred to as a direct reflection.

If the test OI does collide with other OI, but does so a manner in which the velocity component along the Y-direction of the test OI is not increased to a value large enough to overcome the remaining increase in generic potential required to enter constant region 8, the test OI will also return to constant region 6. This process can be referred to as an indirect reflection. If, on the other hand, the test OI does collide with other OI in a manner in which the test OI is able to diffuse into the constant region 8, the test OI can be considered to have been indirectly transmitted through the second transition region 7.

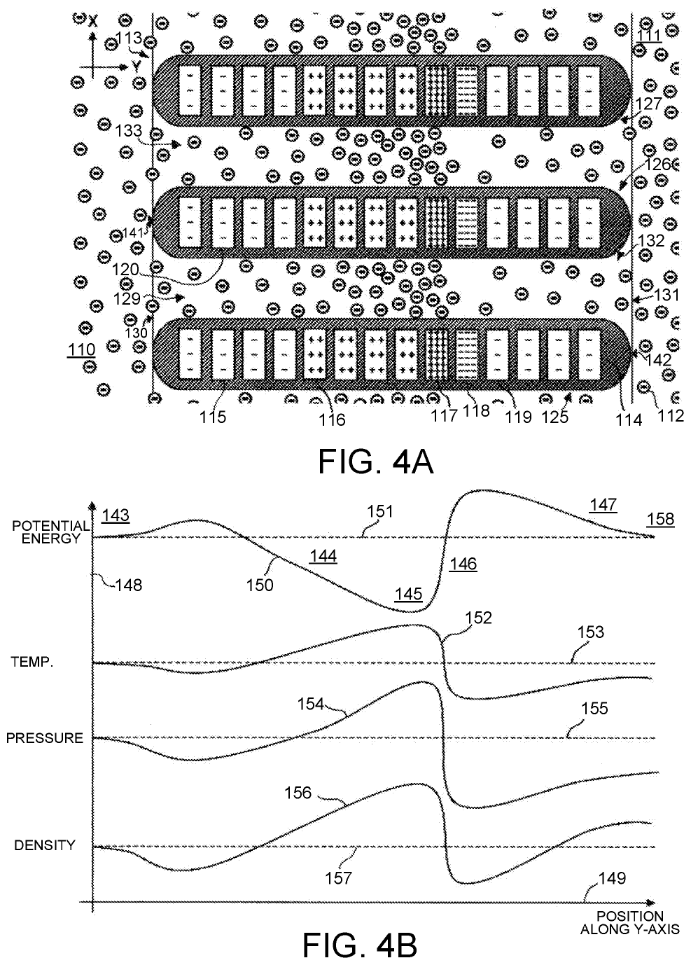

An OI in the constant region 8 can also diffuse to constant region 6 via direct or indirect transmission, as defined above. For the given topography of the generic potential energy, an OI in constant region 8 cannot be directly reflected by the second transition region 7, because the force generating apparatus responsible for the change in the generic potential in the second transition region 7 does not produce a force with a component in the positive Y-direction in the second transition region in the particular embodiment shown in FIG. 1A. Note that, as soon as the OI arrives in constant region 6 after having left a different constant region, such as constant region 8 or 4, the OI is attributed to constant region 6 in this framework. In other embodiments, an OI entering second transition region 7 from constant region 8 can be directly reflected back into constant region 8. For example, the generic potential energy can increase before it decreases when viewed in the negative Y-direction. Such an initial increase in the generic potential, as exemplified by the generic potential energy 150 in FIG. 4A, can lead to direct reflection of OI entering a second transition region from the second reservoir, for example. An OI entering second transition region 7 from constant region 8 can also return to constant region 8 via indirect reflection, as described above.

In order to describe the principle of operation, one can consider a further simplified scenario in which there are no collisions of OI within second transition region 7. In this scenario, only the OI which are transmitted directly from constant region 6 to constant region 8, or reflected directly back into constant region 6, or transmitted directly from constant region 8 to constant region 6 are considered. This scenario represents the limiting case in which the magnitude of the spatial gradient of the generic potential in the second transition region 7 along the Y-direction is infinitely large. Once the principle of operation is clear, it can readily be adapted to the more accurate, real world scenarios, such as scenarios involving indirect transmission and reflection, or OI subject to different statistical distributions, such as fermions.

Consider OI being directly transmitted from constant region 6 to constant region 8. Immediately prior to entering the second transition region 7, the velocities of the OI are modeled by the Maxwell-Boltzmann distribution in accordance with the simplified model being described. Immediately after exiting the second transition region 7, the velocities of the OI are no longer modeled by the Maxwell-Boltzmann distribution. Due to the lack of collisions within the second transition region 7, as assumed in this illustrative, simplified model, the velocity component along the Y-direction of an OI which arrives in constant region 8 is reduced by a value determined by the difference in the generic potential energy between constant region 8 and constant region 6. The velocities along the X- and Z-directions are unchanged, i.e. they retain their values from constant region 6. As mentioned, only those OI with a sufficiently large velocity component along the Y-direction are able to move directly or freely from constant region 6 to constant region 8. Only a fraction of OI entering the second transition region 7 from constant region 6 are able to move freely into constant region 8, with the remainder being reflected directly back into constant region 6 in the simplified model in which the OI are not assumed to collide with other OI in the second transition region 7. The average kinetic energy of the OI which are able to surmount the generic potential difference encountered during the motion or diffusion from constant region 6 to constant region 8 is lower in constant region 8 compared to constant region 6. After entering constant region 8, the OI in question collide with other OI. Throughout these collisions, the velocity distribution of the OI in question returns to the conventional Maxwell-Boltzmann distribution. In this simplified model, all OI in question are assumed to remain in constant region 8 during this redistribution process, i.e. no OI returns to second transition region 7 prior to the redistribution process being complete. While unrealistic, this assumption simplifies the discussion. The average energy of an OI remains unchanged throughout this redistribution process in the explanatory, simplified model being discussed. In other words, the redistribution is assumed to be adiabatic.

Consider OI being directly transmitted from constant region 8 to constant region 6. Immediately prior to entering the second transition region 7, the velocities of the OI are modeled by the Maxwell-Boltzmann distribution in accordance with the simplified model being described. Immediately after exiting the second transition region 7, the velocities of the OI are no longer modeled by the Maxwell-Boltzmann distribution. Due to the lack of collisions within the second transition region 7, as assumed in this illustrative, simplified model, the velocity component along the Y-direction of an OI which arrives in constant region 6 is increased by a value determined by the difference in the generic potential energy between constant region 8 and constant region 6. The velocities along the X- and Z-directions are unchanged, i.e. they retain their values from constant region 8. As mentioned, for the given topography of the generic potential 11, all OI which enter second transition region 7 from constant region 8 are able to move directly or freely from constant region 8 to constant region 6 in the simplified model in which the OI are not assumed to collide with other OI in the second transition region 7. In other words, there are no direct reflections back into constant region 8. The average kinetic energy of the OI which move or diffuse from constant region 8 to constant region 6 is larger in constant region 6 compared to constant region 8 due to the reduction in the generic potential energy throughout transition region 7 in the negative Y-direction. After entering constant region 6, the OI in question collide with other OI. Throughout these collisions, the velocity distribution of the OI in question returns to the conventional Maxwell-Boltzmann distribution. In this simplified model, all OI in question are assumed to remain in constant region 6 during this redistribution process, i.e. no OI returns to second transition region 7 prior to the redistribution process being complete. While unrealistic, this assumption simplifies the discussion. The average energy of an OI remains unchanged throughout this redistribution process in the explanatory, simplified model being discussed. In other words, the redistribution is assumed to be adiabatic.

In the framework of this model, and for the static boundary condition being discussed, the density and temperature of the medium containing the OI in constant region 8 can be calculated as follows for a given density and temperature of the medium in constant region 6 and a given change in the generic potential energy throughout the second transition region 7. The mass flow rate of OI entering constant region 8 from second transition region 7 must equal the mass flow rate of OI entering second transition region 7 from constant region 8. The energy flow rate entering constant region 8 from second transition region 7 must equal the energy flow rate of OI entering second transition region 7 from constant region 8. These two constraint equations can be solved for the temperature and the density of OI in constant region 8. The constraints can also be enforced at the interface of the second transition region 7 and constant region 6 instead, or at any point within second transition region 7.

A more detailed model will yield more accurate results. The present, simplified model is sufficient for illustrating the general principle of operation, however.

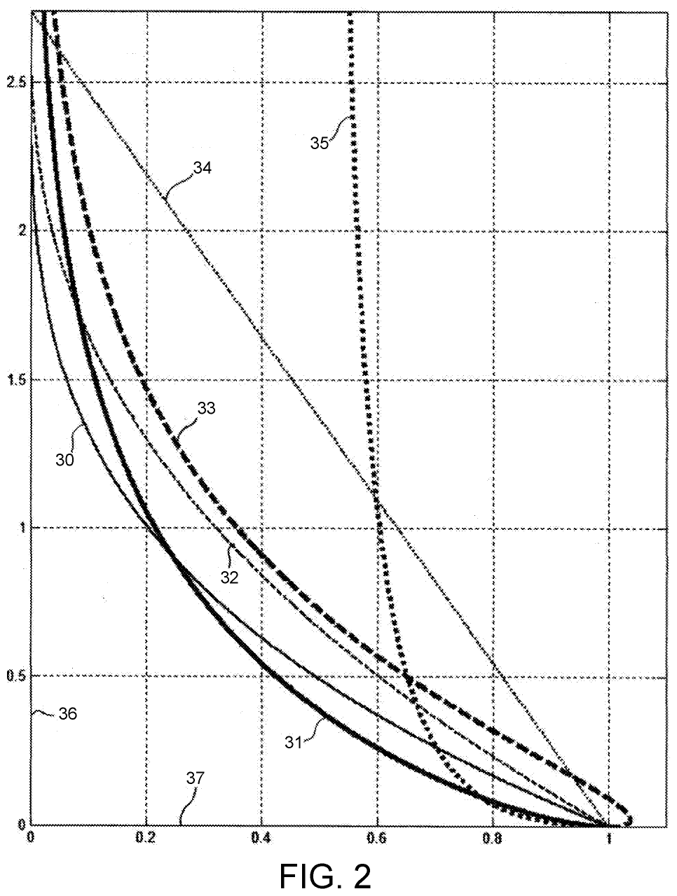

To summarize, the assumptions of the simplified model for FIG. 1B and FIG. 2 are as follows. The OI in the first transition region are assumed to behave like an ideal gas being compressed or expanded adiabatically. The OI in the second transition region do not experience any collisions. The OI can diffuse in the positive or negative Y-direction through the first or second transition region, and a static boundary condition is assumed. The behavior of OI in the constant regions, i.e. any region outside of the transition region, is described by the Maxwell-Boltzmann distribution. Immediately prior to diffusing through the second transition region, the behavior of OI is described by the Maxwell-Boltzmann distribution. Immediately after diffusing through the second transition region and prior to diffusing through any other transition region, the velocity distribution of OI returns to the Maxwell-Boltzmann distribution adiabatically. The exemplary embodiment in FIG. 1B features additional assumptions, such as the assumption that the generic potential energy varies spatially as opposed to temporally, the assumption that the force generating apparatus produces a force acting on OI which is constant in magnitude, direction, time and space throughout a transition region, the assumption that the ideal gas is monatomic, or the assumption that the generic potential energy in the first reservoir and the second reservoir is identical, for example.

FIG. 2 is a plot of several physical properties as a function of a change in the depth of a potential well for an exemplary embodiment of the invention for the aforementioned instructive, simplified model. Under the assumptions mentioned in the preceding paragraphs in the context of FIG. 1B, FIG. 2 can be considered to explain the thermodynamic properties of a medium similar to the medium containing OI in FIG. 1A and FIG. 1B.

In FIG. 2, the vertical axis 36 describes the generic potential energy level. The units of the vertical axis 36 are arbitrary and not intended to limit the scope of the invention. The horizontal axis 37 describes the value of a specified physical property normalized by the value of the specified physical property at the reference generic potential energy level, which is set to zero.

Thin solid line 30 describes the variation of pressure of an ideal gas, shown along the horizontal axis 37, as a function of the generic potential energy, shown along axis 36. This variation of the pressure is equivalent to the variation of the pressure of an ideal gas during an adiabatic compression. Thin dashed line 32 describes the variation of the density of an ideal gas corresponding to the variation of the pressure 30. Thin dotted line 34 describes the variation of the temperature of an ideal gas corresponding to the variation of the pressure 30. Accordingly, the variation of the temperature 34 is a linear function of the value of the generic potential energy.

Thick solid line 31 describes the value of the pressure of a second constant region, such as constant region 8 in FIG. 1B, for a given pressure in a first constant region, such as constant region 6 in FIG. 1B, for a given generic potential energy in the second constant region relative to the generic potential energy in the first constant region, where the first and the second constant region are separated by a sufficiently large spatial or temporal gradient in the generic potential energy. Similarly, thick dashed line 33 describes the value of the density in a second constant region, and thick dotted line 35 describes the value of the temperature in a second constant region. As mentioned, in the case of a spatial gradient in the generic potential energy, the magnitude of the difference in generic potential energy is on the other of the magnitude of the kinetic energy associated with the motion of the OI in the specified spatial direction, and the magnitude of the difference in the position is on the order of the smallest mean free path of an OI in an adjacent constant region, such as the mean free path in constant region 6 in FIG. 1B. In the case of a temporal gradient in the generic potential energy, the magnitude of the difference in generic potential energy is on the other of the magnitude of the kinetic energy associated with the motion of the OI parallel to the direction of the force produced by the force generating apparatus associated with the generic potential energy change, and the magnitude of the difference in time is on the order of the smallest mean free time of an OI in an adjacent constant region, such as the mean free time in constant region 6 in FIG. 1B. The mean free time is the average time between collisions for an OI. Note that pressure 31, density 33, and temperature 35 are calculated using the aforementioned simplifying assumptions, and are therefore only intended to sketch the approximate behavior of OI encountering a large gradient in the generic potential energy for a given boundary condition. Further note that the lines describing the pressure 31, density 33, and temperature 35 are not describing the variation of pressure, density, or temperature as a function of space or time through a transition region or transition period with a sufficiently large gradient, such as second transition region 7 in FIG. 1B, but rather the pressure, density, or temperature in a constant region, such as constant region 8 in FIG. 1B, i.e. at a location or a period of time following the aforementioned redistribution process. This is in contrast to the pressure 30, density 32, and temperature 34, which can be considered to also describe the variation of pressure, density, or temperature as a function of space or time through a transition region or transition period with a sufficiently gradual or sufficiently smooth gradient, such as first transition region 5 in FIG. 1B. Line 30 can be considered to describe the pressure at the beginning and during a smooth and gradual adiabatic compression, while line 31 describes the pressure after a discontinuous expansion and subsequent redistribution process, subject to the aforementioned simplifying assumptions.

Consider the following example, which, unless specified, shares similarities with the example embodiment shown in FIG. 1A, where the similarities pertain to the topography of the generic potential energy as well as the underlying assumptions, for instance. A boundary condition can be provided by a first reservoir or a first constant region, such as first constant region 4 in FIG. 1B. In this first constant region, the generic potential energy can correspond to a value of 0.5 shown in FIG. 2, and the pressure, density, and temperature in the first constant region can correspond to the value of the pressure 30, density 32, and temperature 34 at the given value of the generic potential energy, i.e. 0.5. In a first transition region, the medium comprising OI can be compressed gradually in a manner equivalent to the adiabatic compression of an ideal gas within a first transition region. As mentioned, OI can diffuse through this transition region in the positive or negative Y-direction, throughout which the OI can be considered to experience a compression or expansion, respectively, resulting in a decrease or increase in the generic potential energy. Having diffused through the first transition region from the first constant region, the OI encounter a second constant region, similar to constant region 6 in FIG. 1B. In the second constant region, the pressure, density, and temperature assume the values corresponding to the potential energy of 0 in FIG. 2. The change of the pressure, density, and temperature in the first transition region is described by the portion of lines 30, 32, and 34, respectively, which lie between a generic potential energy of 0 and a generic potential energy of 0.5. From the second constant region, OI are able to diffuse through a second transition region, similar to second transition region 7 in FIG. 1B, to a second reservoir or third constant region, similar to constant region 8 in FIG. 1B, and vice versa. The second transition region is configured in accordance with the assumptions of FIG. 2. In the third constant region, the generic potential energy also corresponds to a value of 0.5 shown in FIG. 2, similar to the first constant region, in this particular example. The pressure, density, and temperature in the third constant region correspond to the value of the pressure 31, density 33, and temperature 35 at the given value of the generic potential energy, i.e. 0.5.

In this example, the temperature and pressure in the second reservoir are lower than the temperature and pressure in the first reservoir. The density in the second reservoir is larger than the density in the first reservoir. Note that the thermodynamic properties in the first reservoir and the second reservoir are different, despite the generic potential energy associated with each reservoir being identical in this example. A similar scenario is also illustrated in FIG. 1B, where the pressure 15 and temperature 13 are lower in constant region 8, i.e. the second reservoir 2, compared to constant region 4, i.e. the first reservoir 1 as a result of the topography of the generic potential energy 11 and the diffusion of OI in the positive and negative Y-direction for a static boundary conditions. The density 17 is larger in constant region 8 compared to constant region 4.

The aforementioned example scenario can be adapted to a dynamic boundary condition as follows. In the static boundary condition, the force generating apparatus, which is responsible for generating the topography, i.e. the spatial or temporal variation, of the generic potential energy, experiences a force acting in the positive Y-direction in FIG. 1B. This is due to the larger pressure in the first reservoir 1 compared to the pressure in the second reservoir 2. More specifically, the force exerted by the OI on the force generating apparatus in the second transition region 7 in the positive Y-direction is larger than the force exerted by the OI on the force generating apparatus in the first transition region 5 in the negative Y-direction. This results in a net force or a net pressure on the force generating apparatus in the positive Y-direction for the static boundary condition. For the dynamic boundary condition, consider a scenario in which the pressure in the first reservoir 1 is artificially maintained to be equal to the pressure in the second reservoir 2. For example, the first reservoir can be identical to the second reservoir. Compared to the static boundary condition for the scenario shown in FIG. 1B, the pressure in the first reservoir 1 can be considered to have been reduced to the pressure of the second reservoir 2. As a result, for in a steady configuration, there is a net diffusion or a net flow of OI from the second reservoir 2 to the first reservoir 1 through the potential well 11 in this example, i.e. for the given assumptions. The net motion of OI is associated with a net force acting on the force generating apparatus in the positive Y-direction. For example, in other embodiments, the OI can be air molecules, and the first reservoir 1 and the second reservoir 2 can be the atmosphere of earth, i.e. the first and second reservoir are identical. In this case, the force generating apparatus responsible for the generic potential energy topography can be used to generate a net flow of air molecules. The net motion of the air molecules is associated with a reduction in the temperature of the air and a force acting on the force generating apparatus. The operation of an embodiment in the aforementioned example is similar to the operation a cold gas thruster. The force acting on the force generating apparatus can be employed to do mechanical work. For instance, force can be used to accelerate the force generating apparatus, or balance the drag force acting on the force generating apparatus or any other apparatus attached thereto, such as a fuselage, wing, or hull of a ship. The force can also be have a vertical component, i.e. the force can be used to generate aerodynamic or hydrodynamic lift. The mechanical work can also be converted into electrical energy by means of an electric generator. Embodiments of the invention can also be considered for applications involving pumping. In the case in which the OI carry charge, embodiments of the invention can be employed to produce electrical work. This electrical work can also be converted into mechanical work by means of an electric motor. Embodiments of the invention can therefore also be considered for applications involving power generation. Such applications, as well as related apparatuses and methods, are well known in the art.

In some embodiments, a thermodynamic device can be located at the interface between the first reservoir 1 and the first transition region 5. The thermodynamic device can be an axial or centrifugal turbine or compressor, a duct, or a nozzle, for example. The compressor or turbine can alternatively, or concurrently, comprise a reciprocating piston in some embodiments. In some embodiments, a compression can be carried out by a duct or an artificial modification of the flow of the medium comprising OI, i.e. a decrease or increase in the cross-sectional area of the flow, depending on the flow speed. An expansion can be carried out in similar manner. In some embodiments, a nozzle can be configured to allow higher pressure medium downstream of the first transition region 5 to expand and accelerate before entering the first reservoir 1. In another example, a turbine can be used to extract mechanical work during the expansion of a higher pressure medium downstream of the first transition region 5 prior to entering the first reservoir 1.

Alternatively or concurrently, in some embodiments, a thermodynamic device can be located at the interface between the second reservoir 2 and the second transition region 7. The thermodynamic device can be an axial or centrifugal turbine or compressor, a duct, or a nozzle, for example. For example, a compressor can be employed to compress the medium prior to entering the second transition region from the second reservoir 2. This can be used to increase the density of OI and reduce the size of the force generating apparatus for a given amount of net force acting on the force generating apparatus due to interaction with OI for some embodiments. Alternatively, a turbine can be employed to expand the medium prior to entering the second transition region from the second reservoir 2. This reduction in density can increase the mean free path of OI in the second transition region 7 and reduce the number of collisions an OI experiences within second transition region 7 for a given average gradient of the generic potential energy in the second transition region 7. This can improve the efficacy of the embodiment for a given topography of the generic potential energy for some embodiments.

In another example, an axial flow compressor can be used to compress the medium after it leaves second reservoir 2 and before it enters the second transition region 7, and an axial flow turbine can be used to expand the flow after it exits first transition region 5 and before it enters first reservoir 1. During this expansion process, more mechanical work can be done by the fluid than is done on the fluid by the compressor, for some embodiments or applications. In other embodiments, the medium is expanded before it enters the second transition region 7, and compressed after it exits first transition region 5 and before it enters first reservoir 1. As before, during the expansion process, more mechanical work can be done by the fluid on the expansion apparatus compared to the work done on the fluid by the compressing apparatus, for some embodiments or applications. This is due to the increased pressure of the medium after exiting first transition region 5, i.e. before entering the compressor, compared to the pressure of the medium before entering second transition region 7, i.e. after leaving the turbine.

In other embodiments, such as embodiments in which the depth of the potential well is larger than the depth of potential well 11, the pressure in constant region 8 can be larger than the pressure in constant region 4 for the static boundary condition, and there can be bulk flow of OI from constant region 4 to constant region 8, i.e. from the first reservoir 1 to the second reservoir 2, through the potential well for the corresponding dynamic boundary condition.

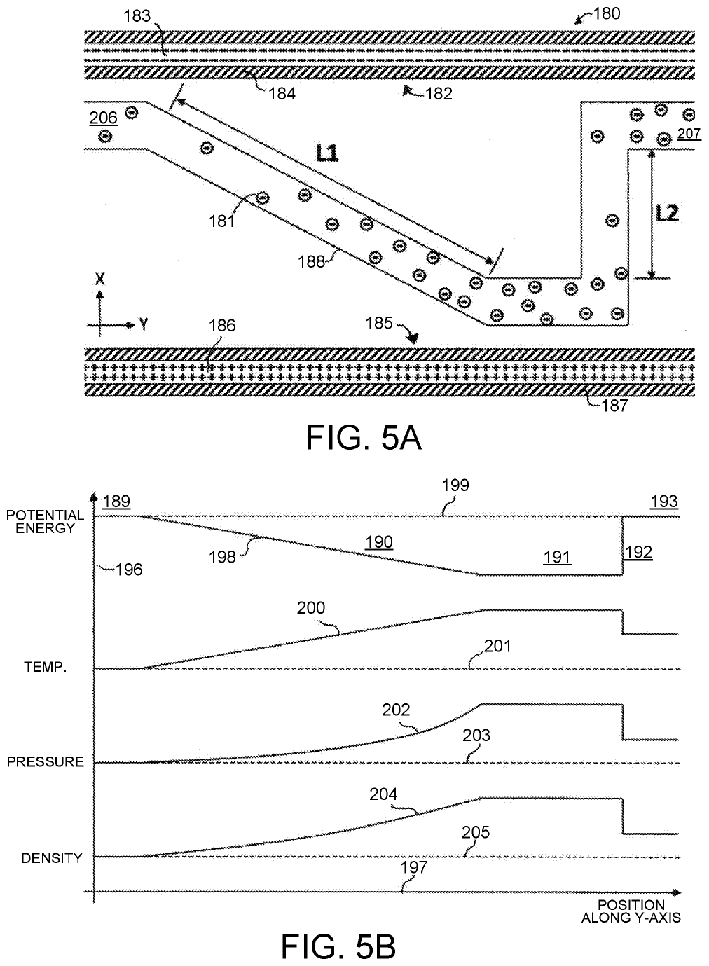

Consider the following example, which, unless specified, shares similarities with the example embodiment shown in FIG. 5A, where the similarities pertain to the topography of the generic potential energy along the path of diffusion of OI as well as the underlying assumptions, for instance. A boundary condition can be provided by a first reservoir or a first constant region, such as first constant region 189 in FIG. 5B. In this first constant region, the generic potential energy can correspond to a value of 1.5 shown in FIG. 2, and the pressure, density, and temperature in the first constant region can correspond to the value of the pressure 30, density 32, and temperature 34 at the given value of the generic potential energy, i.e. 1.5. In a first transition region, the medium comprising OI can be compressed gradually in a manner equivalent to the adiabatic compression of an ideal gas within a first transition region. As mentioned, OI can diffuse through this transition region in the positive or negative Y-direction, throughout which the OI can be considered to experience a compression or expansion, respectively, resulting in a decrease or increase in the generic potential energy. Having diffused through the first transition region from the first constant region, the OI encounter a second constant region, similar to constant region 191 in FIG. 5B. In the second constant region, the pressure, density, and temperature assume the values corresponding to the potential energy of 0 in FIG. 2. The change of the pressure, density, and temperature in the first transition region is described by the portion of lines 30, 32, and 34, respectively, which lie between a generic potential energy of 0 and a generic potential energy of 1.5. From the second constant region, OI are able to diffuse through a second transition region, similar to second transition region 192 in FIG. 5B, to a second reservoir or third constant region, similar to constant region 193 in FIG. 5B, and vice versa. The second transition region is configured in accordance with the assumptions of FIG. 2. In the third constant region, the generic potential energy also corresponds to a value of 1.5 shown in FIG. 2, similar to the first constant region, in this particular example. The pressure, density, and temperature in the third constant region correspond to the value of the pressure 31, density 33, and temperature 35 at the given value of the generic potential energy, i.e. 1.5.

In this example, the pressure, density, and temperature in the second reservoir are larger than the pressure, density, and temperature in the first reservoir. Note that the thermodynamic properties in the first reservoir and the second reservoir are different, despite the generic potential energy associated with each reservoir being identical in this example. As mentioned, note that, in general, the value of the generic potential energy in the second reservoir need not be equal to the value of the generic potential energy in the first reservoir. A similar scenario is also illustrated in FIG. 5B, where the pressure 202, density 204, and temperature 200 are larger in constant region 193, i.e. the second reservoir, compared to constant region 189, i.e. the first reservoir, as a result of the topography of the generic potential energy 198 and the diffusion of OI in the positive and negative Y-direction for a static boundary conditions.

The aforementioned example scenario can be adapted to a dynamic boundary condition in a similar manner as the aforementioned example in which the first constant region is at a generic potential energy corresponding to a value of 0.5 in FIG. 2. The net flow of OI for a dynamic boundary condition is in the positive Y-direction, from the first constant region 189 to the third constant region 193, i.e. from the first reservoir to the second reservoir.

In some embodiments, the generic potential energy in constant region 8 is lower than the generic potential energy in constant region 4. In other embodiments, the generic potential energy in constant region 8 is higher than the generic potential energy in constant region 4.

In some embodiments, there is only a single transition region, where the transition region is configured in a manner similar to transition region 7 in FIG. 1B. The transition region can be located between a first reservoir and a second reservoir, for example. Such embodiments can be considered to comprise a generic potential step. The transition region can be configured in a manner in which the number of collisions of an OI per unit change in generic potential energy in time or in space is changed compared to a baseline scenario. The baseline scenario can be a scenario in the prior art, such as a scenario in which the properties of the medium comprising the OI change according to a conventional compression or expansion, i.e. a conventional change in the generic potential energy. For example, if the medium can be described as an ideal gas, the baseline scenario can be modeled as a compression or expansion of an ideal gas. The compression or expansion can be adiabatic if there is no heat exchanged with the environment, for example. As mentioned, in some embodiments, heat can be exchanged with the environment. The compression or expansion can be isothermal or isobaric, for instance. In other words, the transition region can be configured in a manner in which the compression or expansion of a medium comprising OI deviates from the conventional behavior, such as ideal gas behavior. To that end, the gradient of the generic potential energy in space or time can be sufficiently large in the transition region. The gradient is the ratio of a change in generic potential energy over a corresponding change in position or time. For instance, the change in position can be less than or equal to several orders of magnitude larger than order of magnitude of the mean free path of OI for a corresponding change in the generic potential energy, where the change in the generic potential energy is larger than or equal to several orders of magnitude smaller than the average energy of an OI. Alternatively or concurrently, the change in time can be less than or equal to several orders of magnitude larger than order of magnitude of the mean free time of OI for a corresponding change in the generic potential energy, where the change in the generic potential energy is sufficiently large to produce a measurable deviation from the reference or baseline scenario in the behavior of the medium comprising OI throughout the transition region. In accordance with some embodiments of the invention, for the static boundary condition, the OI flowing or diffusing from the first reservoir to the second reservoir through the single transition can experience a change in entropy compared to the baseline scenario. The change in entropy can be a reduction, for example. For a dynamic boundary condition, the OI flowing through the transition region can also experience a change in the entropy, where the change can be a reduction, for example. Embodiments of the invention comprise at least one such transition region.

In the embodiments described in FIGS. 1-5 the generic potential energy forms a generic potential well. In other words, the generic potential energy decreases on average in a first transition region, such as first transition region 5 in FIG. 1B, in the positive Y-direction, and increases on average in a second transition region, such as second transition region 7, in the positive Y-direction, such that the generic potential energy in between the first transition region and the second transition region is lower than the generic potential energy in the first reservoir, such as first reservoir 1, and, lower than the generic potential energy in the second reservoir, such as second reservoir 2. As mentioned, some embodiments can comprise a generic potential step. Note that embodiments comprising a potential well also comprise a potential step. Some embodiments can comprise a generic potential hill. In other words, the generic potential energy increases on average in a first transition region in the positive Y-direction and decreases on average in a second transition region in the positive Y-direction such that the generic potential energy in between the first transition region and the second transition region is larger than the generic potential energy in the first reservoir located in the negative Y-direction of the first transition region, and larger than the generic potential energy in the second reservoir located in the positive Y-direction of the second transition region, where the second transition region is located in the positive Y-direction of the first transition region. As before, the generic potential energy in the second reservoir need not be identical to the generic potential energy in the first reservoir, and the magnitude of the gradient of the generic potential energy in the second transition region relative to the magnitude of the gradient of the generic potential energy in the first transition region can be configured in a similar manner as the magnitude of the gradient of the generic potential energy in the second transition region 7 in FIG. 1B relative to the magnitude of the gradient of the generic potential energy in the first transition region 5 in FIG. 1B. The behavior of the thermodynamic properties of the medium containing OI throughout the first and second transition regions of a generic potential hill can be determined in a similar manner as described in the context of FIG. 1B and FIG. 2, for example. A generic potential hill can be employed to change the entropy of a medium comprising OI in a similar manner as a generic potential well. This change can occur for a static or dynamic boundary condition, for instance.

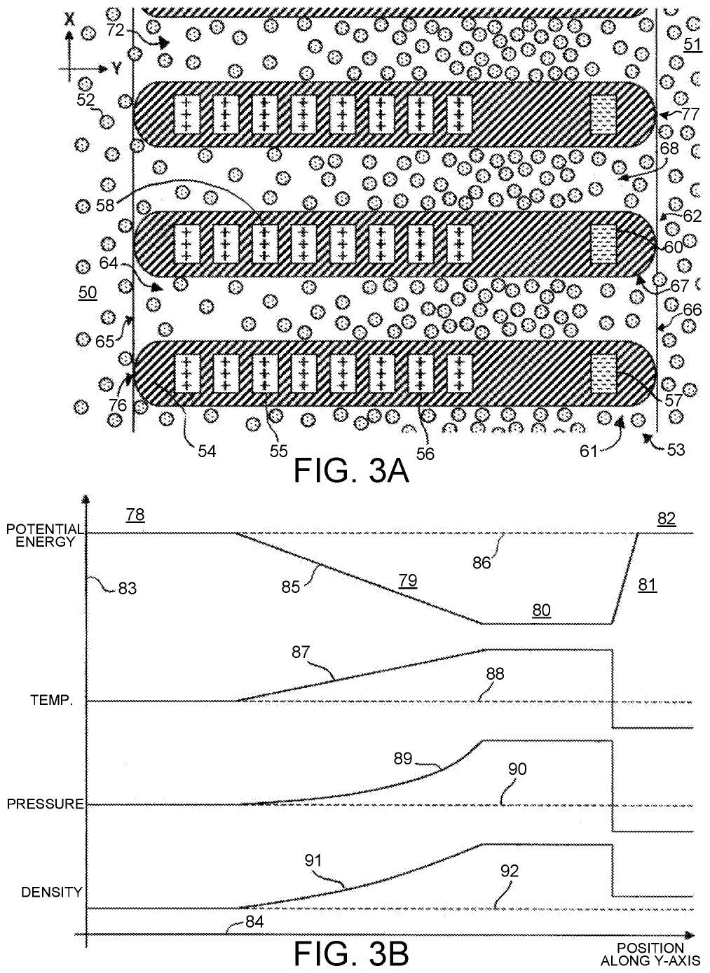

FIG. 3A is a cross-sectional view of an exemplary embodiment of the invention.

FIG. 3B is a schematic plot of several physical properties as a function of position for the exemplary embodiment shown in FIG. 3A. Some features of the exemplary embodiment shown in FIG. 3A as well as some of the principles of operation of the exemplary embodiment share similarities with features and principles of operation described by the other figures, and will therefore not be described in the same detail in the context of FIG. 3A, and vice versa.

FIG. 3A shows a first reservoir 50 separated from a second reservoir 51 by a filtration apparatus 53. In the configuration shown, the first reservoir 50 and the second reservoir 51 are subject to a static boundary condition. In the first reservoir 50 and the second reservoir 51, the medium comprises OI which are schematically represented by individual particles, such as the schematic representation of particle 52. For simplicity, the medium can be considered to be an ideal gas comprising monatomic molecules. In other embodiments the medium can consist of other types of objects, as mentioned. In other embodiments, the medium can be air, for example. For example, the nitrogen and oxygen molecules can be polarized by an external electric field.

In the exemplary embodiment shown in FIG. 5A, the OI can be electrically polarized by an externally applied electric field. As mentioned, in other embodiments, the OI can carry permanent electric dipoles. For instance, the OI can comprise water molecules.

Filtration apparatus 53 comprises a bulk material 54. The bulk material can be a metal such as aluminium, or steel, or a ceramic or a glass. The bulk material can also be a composite, such as a glass fiber or carbon fiber composite.

Filtration apparatus 53 comprises a first surface 76 which faces the first reservoir 50 and a second surface 77 which faces the second reservoir 51. Several identical channels, such as channel 64, channel 68, or channel 72 allow OI to diffuse or flow between the first reservoir 50 and the second reservoir 51. In the depicted exemplary embodiment, the channel is circular in cross-section when viewed along the Y-direction. In other embodiments, the cross-section when viewed along the Y-direction can be rectangular, elliptical, hexagonal, or polygonal, for example. A channel can also be annular in cross-section. For example, in other embodiments, a first portion of the bulk material can be cylindrical in cross-section when viewed along the Y-direction, and a second portion can enclose an annular channel, which encloses the first portion. The dimension of a channel along the Z-direction can also be significantly larger than the dimension of the channel along the X-direction. In other embodiments, the channels need not be identical. A channel, such as channel 64, comprises a first opening 65 facing the first reservoir 50, and a second opening 66, facing the second reservoir 51. A channel also features an interior surface, such as interior surface 67.

The individual channels are arranged in a uniform, square lattice structure when viewed along the Y-direction. In other words, the distance of separation between the centerlines of adjacent channels is identical in the X-direction and Z-direction, where the centerline marks the axis of symmetry of a cylindrical channel parallel to the Y-direction. Accordingly, portion 61 of bulk material 54 is rigidly connected to portion 62 of bulk material 54. Said axis of symmetry of a cylindrical channel can be considered to also be an axis of symmetry for a portion of the filtering apparatus 53 surrounding a channel, such as the portion of filtering apparatus comprising portion 62 and portion 61. In other embodiments, the channels can be arranged in a hexagonal pattern.

In the bulk material surrounding each channel there are several charge collections, such as positive charge collection 55, positive charge collection 56, or negative charge collection 57. The charge collections can surround a channel continuously in some embodiments. In other words, charge collection 58 and charge collection 55 can be a continuous charge collection. This can also be the case for charge collection 57 and charge collection 60. For instance, a collections of charge can comprise an annular disc of conducting material arranged around a circular channel. In some embodiments, the charge collections are insulated from other charge collections. In other words, charge collection 58 and charge collection 55 can be electrically insulated from one another. For instance, the collections of charge can consist of an annular segments arranged around a channel, where the segments are separated by electrically insulating material. In the case in which the bulk material is a conducting material such as metal, the charge collections can be electrically insulated from the bulk material and from one another by an electrical insulator such as glass, ceramic, or plastic. Note that, in such embodiments, the bulk material between the charge collections and the interior of the channel should be configured in a manner in which the desired topography of the electric field within a channel can be achieved. For example, the portion of the bulk material located immediately between a channel and a collection of charge can be constructed of an electrically insulating material such as glass. The filtering apparatus 53 can be manufactured using methods known in the art of semiconductor manufacturing, for example.

In the exemplary embodiment in FIG. 3A, the net charge of the charge collections is zero. The amount of positive charge is equal to the amount of negative charge embedded within filtration apparatus 53. In other embodiments, a filtration apparatus 53 can carry a net charge.

A collection of charge can comprise an electrical conductor, such as a metal, such as copper or silver. A collection of charge can be charged by applying a voltage difference between a first collection of charge, such as collection of charge 56, and a second collection of charge, such as collection of charge 57. The voltage difference can be applied by a battery, for example. The voltage at a collection of charge can be delivered to a collection of charge from a voltage source by an electrical conductor, such as a copper wire. In some embodiments, the magnitude of the voltage applied to a conductor within a collection of charge can be regulated, controlled, or modified. For instance, the amount of charge located within a given collection of charge can be regulated by changing the voltage applied to a collection of charge, ceteris paribus. In some embodiments, a collection of charge can comprise several charged molecules or ions embedded within the bulk material 54, or embedded within a material which itself is embedded within bulk material 54. For example, a collection of charge can comprise a fluid, such as water, which comprises free floating ions, where the fluid can be contained within bulk material 54.

The purpose of the collections of charge in this exemplary embodiment is the generation of a suitable electric field topography within a channel. The electric field within a channel as a non-zero component along the Y-direction on average. The magnitude of the component of the electric field along the Y-direction increases in the positive Y-direction in the first transition region 79, and decreases in the positive Y-direction in the second transition region 81. Due to the presence of the electric field in a channel, the OI are polarized. Due to the increasing magnitude of the electric field in the positive Y-direction in the first transition region, the polarized OI experience a force acting in the positive Y-direction in the first transition region. Similarly, the OI experience a force in the negative Y-direction in the second transition region. The collections of charge can therefore be considered to be components of a force generating apparatus. A change in position of an OI in the presence of a force produced by the force generating apparatus can be considered to be associated with a change the generic potential energy of an OI.

The size of a channel along the X-, and Z-direction is a function of the desired topography of the electric field within a channel and the configuration of the electric field generating apparatus. The length of a channel along the Y-direction is a function of the length of the first and second transition regions, as well as structural concerns. Note that a longer channel will be typically increase drag for a dynamic boundary condition, ceteris paribus.

In FIG. 3B, the vertical axis 83 indicates the value of a specified physical property, and the horizontal axis 84 indicates the position along the Y-axis at which said physical property is measured.

In FIG. 3B the value of the average generic potential energy of an OI at the specified position along the Y-direction is indicated by line 85. In this particular exemplary embodiment, the generic potential energy of individual OI within the first reservoir 50 is constant in space and time, as indicated by constant region 78. The generic potential energy within the second reservoir 51 is also constant in space and time, as indicated by constant region 82. The potential energy of an individual OI in the first reservoir 50 and the second reservoir 51 is identical in this simplified example. The horizontal dashed line 86 indicates the value of the generic potential energy in the first reservoir 50 for reference. As mentioned, the generic potential energy 85 is the generic potential energy associated with the force generating apparatus, i.e. the field generating apparatus, which comprises collections of charge, such as charge collection 56. In other embodiments, the generic potential energy 85 in the first reservoir 50 can be larger or smaller than the generic potential energy in the second reservoir 82.

Note that the depicted topography of the generic potential energy 85 is a simplified representation of the actual topography of the generic potential energy produced by the collections of charge along a centerline or along the axis of symmetry of a channel, which can be readily calculated.

In the first transition region 79 there is a force applied to the polarized OI directed in the positive Y-direction, resulting in a gradual spatial decrease in the generic potential energy of OI in the positive Y-direction. In a constant region 80 the generic potential energy can be considered to be constant in a simplified model. In the second transition region 81 there is a force applied to the polarized OI directed in the negative Y-direction, resulting in a spatial increase in the generic potential energy of OI in the positive Y-direction. In the depicted embodiment, the average magnitude of the spatial gradient of the generic potential energy in the second transition region 81 is larger than the average magnitude of the spatial gradient of the generic potential energy in the first transition region 79. The behavior of OI throughout a channel is similar to the behavior of OI in the exemplary embodiment shown in FIG. 1A.

In FIG. 3A, line 87 illustrates the variation of the temperature of OI as a function of position along the Y-axis. The horizontal dashed line 88 indicates the value of the temperature of the medium in the first reservoir 50 for reference. Line 89 illustrates the variation of the pressure of OI as a function of position along the Y-axis. The horizontal dashed line 90 indicates the value of the pressure of the medium in the first reservoir 50 for reference. Line 91 illustrates the variation of the density of OI as a function of position along the Y-axis. The horizontal dashed line 92 indicates the value of the density of the medium in the first reservoir 50 for reference.

In FIG. 3A, the OI can also be virtual particles, or vacuum fluctuations, as described by quantum field theory. For example, the medium can comprise virtual particles with a permanent or induced electric dipole. Note that the medium comprising OI need not contain electrically neutral particles, but can also comprise separate or independent positively and negatively charged particles, such as positrons and electrons. In the quantum vacuum, virtual positrons and electrons can be considered to arise from quantum vacuum fluctuations and subsequently annihilate each other in a continuous process. The annihilation of a virtual particle can be considered to be a collision, as defined herein. In this scenario, the medium can be considered to comprise fluctuating virtual electric dipoles, even though these dipoles need not be associated with a single particle, as is the case of a water molecule, but can instead be associated with the electrical interaction between at least two independent particles. This also applies to the case in which the particles are real particles, such as mobile negative ions and mobile positive ions. A filtering apparatus, configured in a similar manner as filtering apparatus 113 in FIG. 3A, can therefore be employed to interact with electrical dipoles of any kind, such as the kind found in the quantum vacuum, and such as those formed by multiple charged particles. In a static boundary condition, the thermodynamic properties of the quantum vacuum in a first reservoir on one side of the filtering apparatus can be different to the thermodynamic properties of the quantum vacuum in a second reservoir on the other side of the filtering apparatus. In a dynamic boundary condition, a net flow or a net diffusion of virtual particles through the channels of the filtering apparatus can be established. The size and the geometry of the embodiments of the invention can be adapted to the particular properties of the medium and the OI.

The principles of some embodiments of the invention can also be adapted to other applications, such as applications involving levitation. Consider the following configuration. An electrically insulated positive collection of charge is located in close proximity to an electrically insulated negative collection of charge, where the combined net charge of the positive and negative collections of charge is zero. The positive and negative charge collections are configured identically with the only difference being the sign of the charge they carry. These collections of charge are surrounded by a gas comprising neutrally charged OI, which carry a permanent electrical dipole. For simplicity, it can be assumed that this gas behaves like an ideal gas in the far stream, i.e. an infinite distance from the positive and negative collections of charge. The line connecting the center of the positive and negative collection of charge is denoted the central axis. The plane perpendicular to the central axis which is located half-way between the negative and the positive charge collection is denoted the symmetry plane. The intersection between the symmetry plane and the central axis is denoted the center.

Due to their electric dipoles, the OI are attracted to the positive and the negative charge collection. The resulting generic potential energy of OI is defined to be zero an infinite distance from the center. Due to symmetry the generic potential energy of OI on the symmetry plane is also zero. A test OI moving along the central axis, starting from an infinite distance from the center and moving towards the center, will experience a gradually decreasing generic potential energy until it reaches the first charge collection, which can be the positive or the negative charge collection. Due to the close proximity of the positive or the negative charge collection, the test OI moving from the first charge collection to the center will experience a steeply increasing generic potential energy. At the center the generic potential energy is zero, as mentioned. The topography of the generic potential energy is symmetric about the symmetry plane. The portion of the generic potential energy along the central axis between a collection of charge and the center can be denoted the second transition region. The portion of the generic potential energy along the central axis between a collection of charge and an infinite distance from the center can be denoted the first transition region.

When the collections of charge are located sufficiently close together, the extent of the second transition region along the central axis can be on the order of the mean free path of OI at the symmetry plane, while the extent of the first transition region along the central axis can be several orders of magnitude larger than the mean free path of OI at the nearest collection of charge. As discussed in the context of FIG. 1A and FIG. 2, this can lead to a lower pressure of the medium comprising the OI at the center between the charge collections in a hypothetical static boundary condition. Since the far stream, and infinite distance from the center, and the center itself are connected by the plane of symmetry along which the generic potential energy is unchanged between the far stream and the center, the hypothetical second reservoir at the center and the hypothetical first reservoir in the far stream can be considered to be connected. In other words, the pressure in the first reservoir and the second reservoir can be considered to be identical, which corresponds to a dynamic boundary condition. For the aforementioned hypothetical static boundary condition, there is a net flow or net diffusion of OI from the far stream along the symmetry plane towards the center, and from the center along the central axis towards the far stream, for the corresponding dynamic boundary condition. This flow condition or flow profile can impart a viscous drag force on the collections of charge, which are located within the flow of OI from the center towards the far stream. The drag force is directed away from the center. Thus, a repulsive force can be established between opposite charges due to their interaction with the OI in the medium within which the charges are located. In the absence of other forces, and in equilibrium, this repulsive drag force can balance the attractive Coulomb force between the opposite charges. A similar mechanism can lead to an observed or perceived repulsive force between the negatively charged electrons and the positively charged nuclei of atoms, where the OI are particles contained in the quantum vacuum.

When both collections of charge comprise the same type of charge, as opposed to an opposite charge, the topography of the generic potential energy is such that the first transition region, located along the central axis between the far stream and the first collection of charge, features a larger magnitude in the gradient of the generic potential energy in the proximity of the collection of charge than the second transition region, located between a charge and the center. In this configuration, therefore, the drag force due to the motion of OI in the dynamic boundary condition is an attractive force. A similar mechanism can lead to an observed or perceived attractive force between the positively charged protons in the nuclei of atoms, for example, where the OI are particles contained in the quantum vacuum.

The aforementioned perceived repulsive force between collections of opposite charge can be employed to levitate an apparatus attached to a first collection of charge, such as a negative collection of charge, relative to an apparatus attached to a second collection of charge, such as a positive collection of charge. For example, the OI can be polarizable molecules in air, and the negative collections of charge can be attached to a vehicle and the positive collections of charge can be embedded within a rail. The air surrounding this apparatus, subject to a dynamic boundary condition, can be set in motion in the manner as described above. The resulting drag force acting on the vehicle can be used to cancel the gravitational force acting on the vehicle, resulting in levitation of the vehicle above the rail.

The aforementioned perceived attractive force between collections of equal charge can be employed to increase the contact force between an apparatus attached to a first collection of charge, such as a negative collection of charge, relative to an apparatus attached to a second collection of charge, such as a negative collection of charge. The increased contact force can be employed to increase the frictional force, which can be used to improve the grip between the apparatuses. Examples of applications which would benefit from an increased frictional force are the deceleration or braking of vehicles, the climbing of walls, or the latching together of objects.

FIG. 4A is a cross-sectional view of an exemplary embodiment of the invention.

FIG. 4B is a schematic plot of several physical properties as a function of position for the exemplary embodiment shown in FIG. 4A. Some features of the exemplary embodiment shown in FIG. 4A as well as some of the principles of operation of the exemplary embodiment share similarities with features and principles of operation described by the other figures, and FIG. 1A and FIG. 3A in particular, and will therefore not be described in the same detail in the context of FIG. 4A, and vice versa.

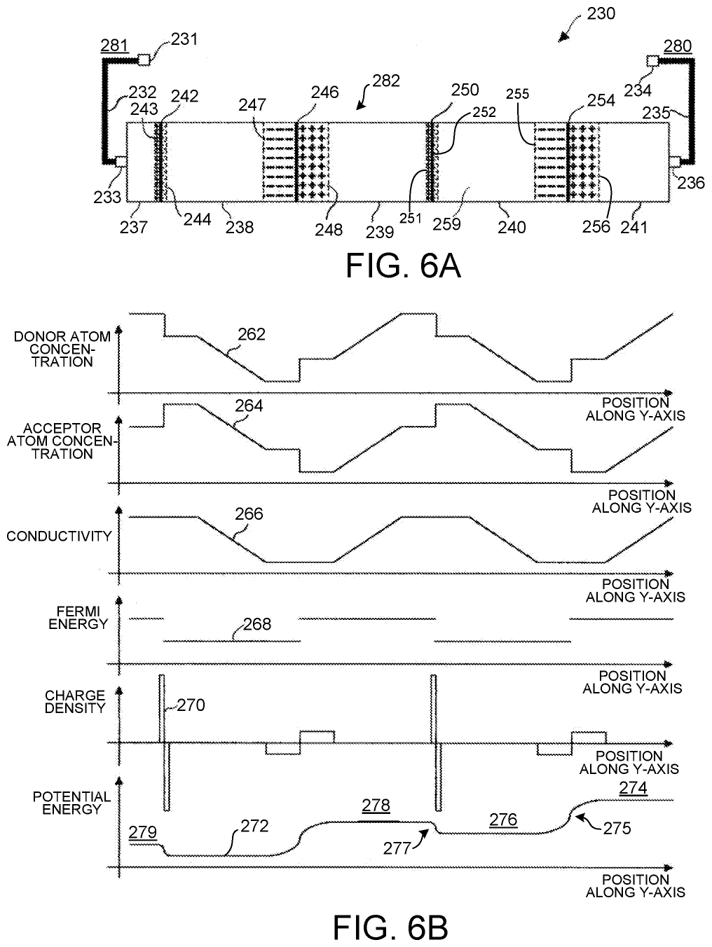

FIG. 4A shows a first reservoir 110 separated from a second reservoir 111 by a filtration apparatus 113. In the configuration shown, the first reservoir 110 and the second reservoir 111 are subject to a static boundary condition. In the first reservoir 110 and the second reservoir 111, the medium comprises negatively charged OI which are schematically represented by individual particles, such as the schematic representation of particle 112. For simplicity, the OI can be considered to behave like an ideal gas. In other embodiments the medium can consist of other types of objects, as mentioned. For example, the OI can be mobile electrons in a conductor or semiconductor, and the medium can also comprise a lattice of metal or semiconductor atoms. Note that the energies of electrons within a semiconductor can be assumed to be described by the Boltzmann distribution in a simplified model. This is known as the Boltzmann tail of the Fermi-Dirac distribution. Note that, in general, embodiments of the invention do not require Boltzmann statistics. A spatial or temporal transition region can be configured with a sufficiently large gradient in space or time of a generic potential energy in a manner in which the distribution of velocities of OI within this transition region deviates from the distribution of velocities of OI for a reference or baseline transition region with an minimal magnitude in the gradient of the generic potential energy. The behavior of OI in a baseline scenario can be described by Fermi-Dirac statistics, found in FIG. 6A, or Bose-Einstein statistics, or Maxwell-Boltzmann statistics, found in FIG. 1A, for example. The Boltzmann distribution is mentioned simply for clarity of description, and not intended to limit the scope of the invention. In another example, the OI can be ionized molecules in a gas. The OI can also be ions suspended in a solution, such as sodium ions in water. The OI can also be lithium ions in a solid electrolyte. Note that the OI can be positively charged in some embodiments.

Filtration apparatus 113 comprises a bulk material 114. The bulk material can be a metal such as aluminium, or steel, or a ceramic or a glass. The bulk material can also be a composite, such as a glass fiber or carbon fiber composite. The bulk material 114 is configured to be perfectly reflective to OI in the exemplary embodiment depicted in FIG. 4A. In other words, OI are not able to be absorbed by or transmitted through bulk material 114. For example, the surface of bulk material 114, which comprises interior surface 132, can comprise a layer of insulating material configured to reflect OI. In other embodiments, bulk material 114 can transmit or absorb a portion of OI, as long as a sufficient remaining portion of OI are reflected by bulk material 114. In some embodiments, bulk material 114 comprises insulating material, such as ceramic, glass, or polymer. The filtering apparatus 113 can be embedded within a conductor or semiconductor in some embodiments. In other embodiments, a channel, such as channel 129, can be a conductor such as a thin copper or semiconductor wire, and the portion of filtering apparatus 113 surrounding the channel, i.e. the field generating apparatus comprising the collections of charge, can be contained in an electrically insulated sleeve around the wire. The thickness or diameter of the wire is chosen to ensure the externally applied electrical field produced by the field generating apparatus, i.e. the collections of charge, is able to penetrate a sufficient portion of the wire. This avoids a short circuit between the first reservoir and the second reservoir. In other embodiments, such as the exemplary embodiment shown in FIG. 6A, the individual collections of charge can be considered to be embedded within the medium comprising the OI. In such embodiments the aforementioned risk of a short circuit is reduced while the ease of manufacture is increased.

Filtration apparatus 113 comprises a first surface 141 which faces the first reservoir 110 and a second surface 142 which faces the second reservoir 111. Several identical channels, such as channel 129, or channel 133, allow OI to diffuse or flow between the first reservoir 110 and the second reservoir 111. In the depicted exemplary embodiment, the channel is circular in cross-section when viewed along the Y-direction. In other embodiments, the cross-section when viewed along the Y-direction can be rectangular, elliptical, hexagonal, or polygonal, for example. A channel can also be annular in cross-section. A channel, such as channel 129, comprises a first opening 130 facing the first reservoir 110, and a second opening 131, facing the second reservoir 111.

The individual channels are arranged in a uniform, square lattice structure when viewed along the Y-direction. In other words, the distance of separation between the centerlines of adjacent channels is identical in the X-direction and Z-direction, where the centerline marks the axis of symmetry of a cylindrical channel parallel to the Y-direction. Accordingly, portion 125 of bulk material 114 is rigidly connected to portion 126 of bulk material 114, which is rigidly connected to portion 127 of bulk material 114. Said axis of symmetry of a cylindrical channel can be considered to also be an axis of symmetry for a portion of the filtering apparatus 113 surrounding a channel, such as the portion of filtering apparatus comprising portion 125 and portion 126. In other embodiments, the channels can be arranged in a hexagonal pattern.

In the bulk material surrounding each channel there are several charge collections, such as negative charge collection 115, positive charge collection 116, positive charge collection 117, negative charge collection 118, negative charge collection 120, or negative charge collection 119. The charge collections can be configured in a similar manner as the charge collections in FIG. 3A. Note that, in general, the individual charge collections in FIG. 3A and FIG. 4A need not be of the same geometric shape or size, and need not carry the same amount of charge. The amount of charge carried by a charge collection is indicated schematically by the plus and minus signs within a charge collection. Note that the number of signs is not indicative of the exact number of positive or negative charges located within a collection of charge, or the distribution of the charges within a charge collection. A difference in the number of signs merely indicates that charge collection 117 carries more positive charge than charge collection 116, and that the magnitude of the charge density in charge collection 116 is larger than in charge collection 115.

A collection of charge can comprise an electrical conductor, such as a metal, such as copper or silver. A collection of charge can be charged by applying a voltage difference between a first collection of charge, such as collection of charge 117, and a second collection of charge, such as collection of charge 118. The voltage difference can be applied by a battery, for example. The voltage at a collection of charge can be delivered to a collection of charge from a voltage source by an electrical conductor, such as a copper wire. In some embodiments, the magnitude of the voltage applied to a conductor within a collection of charge can be regulated, controlled, or modified, as discussed in the context of FIG. 3A.

In the exemplary embodiment in FIG. 4A, the net charge of the charge collections is zero. The amount of positive charge is equal to the amount of negative charge embedded within filtration apparatus 113. In other embodiments, a filtration apparatus 113 can carry a net charge.

The purpose of the collections of charge in this exemplary embodiment is the generation of a suitable electric field topography within a channel. A test OI diffusing through a channel from the first reservoir 110 in the positive Y-direction will initially encounter an electric field with a non-zero component directed in the positive Y-direction due to initially negative charge collections, such as charge collection 115. This electric field exerts a repulsive force on negatively charged mobile OI, where the force is directed in the negative Y-direction. The test OI will therefore initially experience an increase in its generic potential energy, as indicated by generic potential energy 150 in FIG. 4B. A sufficiently far distance in the negative Y-direction from the first opening of the channel, such as first opening 130, the generic potential energy is substantially constant compared to the generic potential energy in a channel, as indicated by constant region 143, in which the level of the generic potential energy is the level of the generic potential energy in the first reservoir 110.

Due to the positive charge collections, such as positive charge collection 116 or positive charge collection 117, located in the positive Y-direction of the initial negative charge collections, the test OI will subsequently experience an electric field with a non-zero component directed in the negative Y-direction. This electric field exerts an attractive force on negatively charged mobile OI, where the force is directed in the positive Y-direction. The test OI will therefore experience a decrease in its generic potential energy, as indicated by a decreasing generic potential energy 150 in a first transition region 144.

Due to the presence of a high density of negative charge in charge collection 118, located in the positive Y-direction of the high density positive charge collections, the test OI will experience a strong electric field with a non-zero component directed in the positive Y-direction. This electric field exerts a force on negatively charged mobile OI, where the force is directed in the negative Y-direction. The test OI will therefore experience a sharp increase in its generic potential energy, as indicated by the increasing generic potential energy 150 in the second transition region 146. Between the first transition region 144 and the second transition region 146, the generic potential energy reaches a minimum in a constant region 145.

Once the test OI has diffused in the positive Y-direction past the second transition region 146, the test OI will encounter an electric field with a non-zero component directed in the negative Y-direction. This electric field exerts a repulsive force on negatively charged mobile OI, where the force is directed in the positive Y-direction. The test OI will therefore experience a decrease in its generic potential energy, as indicated by a decreasing generic potential energy 150 in third transition region 147. A sufficiently far distance in the positive Y-direction from the second opening of the channel, such as second opening 131 the generic potential energy is substantially constant compared to the generic potential energy in a channel, as indicated by constant region 158, in which the level of the generic potential energy is the level of the generic potential energy in the second reservoir 111.

The size of a channel along the X-, and Z-direction is a function of the desired topography of the electric field within a channel and the configuration of the electric field generating apparatus. The length of a channel along the Y-direction is a function of the length of the first and second transition regions, as well as structural concerns. Note that a longer channel will be typically increase drag for a dynamic boundary condition, ceteris paribus.

In FIG. 4B, the vertical axis 148 indicates the value of a specified physical property, and the horizontal axis 149 indicates the position along the Y-axis at which said physical property is measured.

In FIG. 4B the value of the average generic potential energy of an OI within a channel at the specified position along the Y-direction is indicated by line 150. In this particular exemplary embodiment, the generic potential energy of individual OI within the first reservoir 110 is constant in space and time, as indicated by constant region 143. The generic potential energy within the second reservoir 111 is also constant in space and time, as indicated by constant region 158. The potential energy of an individual OI in the first reservoir 110 and the second reservoir 111 is identical in this simplified example. The horizontal dashed line 151 indicates the value of the generic potential energy in the first reservoir 110 for reference. As mentioned, the generic potential energy 150 is the generic potential energy associated with the force generating apparatus, i.e. the field generating apparatus, which comprises collections of charge, such as charge collection 116. In other embodiments, the generic potential energy 150 in the first reservoir 110 can be larger or smaller than the generic potential energy in the second reservoir.

Note that the depicted topography of the generic potential energy 150 is a simplified representation of the actual topography of the generic potential energy produced by the collections of charge along a centerline or along the axis of symmetry of a channel, which can be readily calculated.

In the first transition region 144 there is a force applied to the OI directed in the positive Y-direction, resulting in a gradual spatial decrease in the generic potential energy of OI in the positive Y-direction. In a constant region 145 the generic potential energy can be considered to be constant in a simplified model. In the second transition region 146 there is a force applied to the OI directed in the negative Y-direction, resulting in a spatial increase in the generic potential energy of OI in the positive Y-direction. In the depicted embodiment, the average magnitude of the spatial gradient of the generic potential energy in the second transition region 146 is larger than the average magnitude of the spatial gradient of the generic potential energy in the first transition region 144. The behavior of OI throughout a channel is similar to the behavior of OI in the exemplary embodiment shown in FIG. 1A. In a simplified model, the behavior of OI in first transition region 144 and third transition region 147 can be considered to be identical to be behavior of an ideal gas, and the behavior of OI in the second transition region 146 can be considered to be similar to the behavior of OI in the second transition region 7 in FIG. 1B.

In FIG. 4A, line 152 illustrates the variation of the temperature of OI as a function of position along the Y-axis. The horizontal dashed line 153 indicates the value of the temperature of the medium in the first reservoir 110 for reference. Line 154 illustrates the variation of the pressure of OI as a function of position along the Y-axis. The horizontal dashed line 155 indicates the value of the pressure of the medium in the first reservoir 110 for reference. Line 156 illustrates the variation of the density of OI as a function of position along the Y-axis. The horizontal dashed line 157 indicates the value of the density of the medium in the first reservoir 110 for reference.

FIG. 5A is a cross-sectional view of an exemplary embodiment of the invention.

FIG. 5B is a schematic plot of several physical properties as a function of position for the exemplary embodiment shown in FIG. 5A. Some features of the exemplary embodiment shown in FIG. 5A as well as some of the principles of operation of the exemplary embodiment share similarities with features and principles of operation described by the other figures, and FIG. 4A and FIG. 6A in particular, and will therefore not be described in the same detail in the context of FIG. 5A, and vice versa.

FIG. 5A shows a first reservoir 206 separated from a second reservoir 207 by a filtration apparatus 180. In the configuration shown, the first reservoir 206 and the second reservoir 207 are subject to a static boundary condition. In the first reservoir 206 and the second reservoir 207, the medium comprises negatively charged OI which are schematically represented by individual particles, such as the schematic representation of particle 181. For simplicity, the OI can be considered to behave like an ideal gas. For example, the OI can be mobile electrons in a conductor. The medium through which the OI travels can also comprise other objects, such as the lattice atoms in a metal. These objects are not shown in FIG. 5A. In another example, the OI can be ionized molecules in a gas. In other embodiments the medium can consist of other types of objects, as mentioned. Note that the OI can be positively charged in some embodiments.

Filtration apparatus 180 comprises a force generating apparatus. In this particular embodiment the force generating apparatus comprises a first charge collection apparatus 182, which comprises negative charge collection 183 electrically insulated by insulating material 184. The force generating apparatus also comprises a second charge collection apparatus 185, which comprises positive charge collection 186 electrically insulated by insulating material 187. For both the first and second charge collection, the charges can be contained within a conductor, such as a metal such as copper, for example, and the insulating material can be glass or a ceramic, for example.

The collections of charge, such as collection of charge 183, are arranged parallel to the YZ-plane. The extent of a collection of charge along the Z-direction can be on the order of magnitude of the extent of the channel 188 along the Z-direction in some embodiments. The extent of a collection of charge along the Z-direction can take any value suitable to the operation of exemplary embodiment 180.

As mentioned in the context of FIG. 3A and FIG. 4A, the charge in a collection of charge can be provided by a voltage difference applied between first collection of charge 183 and second collection of charge 186. The voltage difference can be produced by an electric power supply, such as a battery or an electric generator. Electrical conductors, such as metal wires, can connect the electric power supply to the collections of charge.

The collections of charge produce an electric field with a non-zero component in the positive X-direction. A single, negatively charged OI located between the first charge collection 183 and the second charge collection 186 will therefore experience a force directed in the negative X-direction. When more than one negatively charged OI are located between the first charge collection 183 and the second charge collection 186, the electric field experienced by an OI will also be affected by the charge and the locations of other OI relative to the OI. For clarity, this interference effect is neglected in this simplified description.

The benefit of an embodiment such as exemplary embodiment 180 compared to the other embodiments, such as embodiment 113 in FIG. 4A, is the simplicity with which the force generating apparatus can be manufactured, provided, or employed. The force generating apparatus in embodiment 180 is configured to produce a spatially uniform force on OI, where the force is directed in the negative X-direction. This configuration can be adapted to a large variety of different force generating methods. For example, the gravitational force on the surface of earth is also a spatially substantially uniform force. Thus, the force generating apparatus in FIG. 5A can be augmented by, or replaced by, a gravitational force generating apparatus, such as planet earth. Similarly, the embodiment in FIG. 5A can be adapted to the case in which the force generating apparatus is configured to apply an inertial acceleration to the OI. For example, the channel 188 can be accelerated in an inertial frame in the positive X-direction. As a result, the OI within channel 188 experience an apparent, or perceived, body force per unit mass in the negative X-direction, due to their lack of acceleration relative to channel 188 in an inertial frame. For example, channel 188 can be configured to rotate about an axis parallel to the Y-axis and located at first reservoir 206, or located in the positive X-direction relative to first reservoir 206. The channel experiences a centripetal acceleration directed towards the rotation axis due to its rotation in the inertial frame about said rotation axis. The OI within the channel experience an apparent or perceived acceleration in a direction radially outwards from the rotation axis. This perceived acceleration is sometimes referred to as the centrifugal force, even though it is not technically a force. The configuration of embodiment 180 and channel 188 can be thus be adapted to other types of force generating apparatus, and in particular the types of force generating apparatuses in which the direction and magnitude of the associated force acting on the OI cannot easily be controlled, as is the case for gravity, for example. Note that for the embodiment shown in FIG. 1A, the direction of the force acting on OI is reversed for second transition region 7 compared to first transition region 5, and the magnitude of the force acting on OI is larger for second transition region 7 compared to first transition region 5. For the embodiment shown in FIG. 5A, the magnitude and the direction of the force acting on OI in inertial space is unchanged for the first transition region 190 and the second transition region 192.

Channel 188 is square in cross-section when viewed along the lengthwise direction, such as the direction parallel to the Y-axis in first reservoir 206. In some embodiments, channel 188 can be rectangular in cross-section. In other embodiments, channel 188 can be circular, elliptical, or polygonal in cross-section. Channel 188 can also be referred to as a pipe 188 through which OI are able to diffuse, flow, or move. The walls of channel 188 are perfectly reflective to OI in this embodiment.

In FIG. 5A, channel 188 is enveloped by electrically insulating material such as ceramic or glass, similar to insulating material 187 or 184. This insulating material is not shown for clarity. Channel 188 can be a conductor such as a metal or graphite. Embodiment 180 can be manufactured using methods known in the art of semiconductor and microprocessor manufacture.

The extent of channel 188 along the Z-direction can be as large as the extent of channel 188 along the X-direction in the first reservoir 206. The extent of channel 188 along the Z-direction can also be larger or smaller. The extent of channel 188 along the Z-direction can take any value suitable to the operation of exemplary embodiment 180.

In FIG. 5B, the vertical axis 196 indicates the value of a specified physical property, and the horizontal axis 197 indicates the position along the Y-axis at which said physical property is measured.

In FIG. 5B the value of the average generic potential energy of an OI within the channel at the specified position along the Y-direction is indicated by line 198. In this particular exemplary embodiment, the generic potential energy of individual OI within the first reservoir 206 is constant in space and time, as indicated by constant region 189. The generic potential energy within the second reservoir 207 is also constant in space and time, as indicated by constant region 193. The generic potential energy of an individual OI in the first reservoir 206 and the second reservoir 207 is identical in this simplified example. The horizontal dashed line 199 indicates the value of the generic potential energy in the first reservoir 206 for reference. As mentioned, the generic potential energy 198 is the generic potential energy associated with the force generating apparatus, i.e. the field generating apparatus, which comprises collections of charge, such as charge collection 183 or charge collection 186. In other embodiments, the generic potential energy 198 in the first reservoir 206 can be larger or smaller than the generic potential energy in the second reservoir 207.

Note that the depicted topography of the generic potential energy 198 is a simplified representation of the actual topography of the generic potential energy produced by the collections of charge along a centerline or along the axis of symmetry of the channel, which can be readily calculated. For instance, the actual force experienced by an OI is not constant in magnitude and direction regardless of the position of the OI between the first charge collection 183 and the second charge collection 186 in practical embodiments with finite sized charge collections and interference between OI.

Further note that the generic potential energy experienced by a test OI moving along the length of channel 188 is different to the generic potential energy 198, which is projected onto or measured against the Y-axis. The generic potential energy experienced by a test OI along the path it travels within channel 188 can be readily calculated given the geometry of the channel. For instance, the gradient in the generic potential energy in second transition region 192 along the path travelled by an OI, i.e. along length L2, is more shallow or smaller than the gradient of the generic potential energy 198 shown in FIG. 5B. Similarly, the gradient of the generic potential energy in first transition region 190 along the path travelled by an OI, i.e. along length L1, is more shallow or smaller than the gradient of the generic potential energy 198 shown in FIG. 5B.

In the first transition region 198 there is a force applied to the OI directed in the negative X-direction, resulting in a gradual spatial decrease in the generic potential energy of an OI as the OI moves in the negative X-direction and in the positive Y-direction along length L1 of channel 188. In a constant region 191 the generic potential energy can be considered to be constant in a simplified model. In the second transition region 192 there is a force applied to the OI directed in the negative X-direction, resulting in a spatial increase in the generic potential energy of an OI as the OI moves in the in the positive X-direction. In some embodiments, the OI also moves in the positive Y-direction throughout a second transition region, such as second transition region 192. In such embodiments, the distance travelled by an OI in the positive Y-direction in the second transition region is smaller than the distance travelled by an OI in the positive Y-direction in the first transition region, ceteris paribus. In general, in the presence of a spatially and temporally homogenous and isotropic force applied to OI by a force generating apparatus, the smallest angle between the average path travelled by an OI relative to the line of action of the force in a second transition region is more acute than the same angle in a first transition region. In the case in which the generic potential energy in the first reservoir 206 and the second reservoir 207 is identical, the path travelled by an OI in the first transition region, i.e. L1, is longer than the path travelled by an OI in the second transition region, i.e. L2. As a result, in the depicted embodiment, the average magnitude of the spatial gradient of the generic potential energy along the average path travelled by an OI through channel 188 in the second transition region 192, i.e. along length L1, is larger than the average magnitude of the spatial gradient of the generic potential energy along the average path travelled by an OI through channel 188 in the first transition region 198, i.e. along length L2.

Length L1 is larger than the mean free path of OI in constant region 191 in the depicted embodiment 180. As a result, OI experience multiple collisions as they diffuse through section L1 of channel 188 on average. The collisions can be between OI, for instance. In the case in which the interior walls reflect OI diffusely, the collisions between OI and the interior walls of pipe 188 can also have the aforementioned redistribution effect of the energy distribution of OI diffusing along the length of pipe 188.

Within second transition region 192, i.e. along length L2, the average number of collisions experienced by an OI per unit change in the generic potential energy is smaller than the average number of collisions experienced by an OI within first transition region 190, i.e. along length L1. In some embodiments, length L2 is on the order of several order of magnitude larger than the mean free path of OI in constant region 191. In some embodiments, length L2 is on the order of the mean free path of OI in constant region 191. In some embodiments, length L2 is less than the mean free path of OI in constant region 191. Recall that the mean free path is the mean distance travelled between consecutive collisions.

As defined in the context of FIG. 1A, a collision of OI in embodiment 180 is able to change the kinetic energy of an OI in the X-direction. In the case in which the walls of channel 188 are adiabatic, a collision is able to transfer or redistribute energy of an OI between the kinetic energy of the OI along X-direction and the kinetic energy of the OI in the Y- and Z-direction, for example. A collision can thus be considered to be an energy redistribution agent. Note that, in the classical Maxwell-Boltzmann distribution, the average kinetic energy in the X-, Y-, and Z-direction is identical, as described by the equipartition theorem. The term “classical” refers to classical physics which excludes quantum physics, and is used for clarity of description and illustrative purposes, and is not intended to limit the scope of the invention.

An OI experiencing a change in the generic potential energy during free motion, for example, will experience a change in the energy distribution. More specifically, an OI moving in the positive or negative X-direction through channel 188 without encountering any collisions, or while encountering a reduced number of collisions compared to a baseline or reference scenario, will experience a reduction or increase, respectively, in the kinetic energy along the X-direction, while the average kinetic energy along the Y-direction and the Z-direction remains unchanged in this simplified example. This will lead to a departure from the default or baseline type of energy distribution of OI, which, in this case, is the Maxwell-Boltzmann distribution. This is the type of energy distribution in constant region 191, or first reservoir 206, or second reservoir 207, for instance.

In general, a larger average number of collisions per unit change in the generic potential energy leads to an average energy distribution of OI which more closely resembles the baseline energy distribution, such as the Maxwell-Boltzmann energy distribution. Similarly, a smaller number of collisions per unit change in the generic potential energy leads to a departure from the baseline energy distribution. Therefore, the behavior of OI throughout second transition region 192 in FIG. 5B is different compared to the behavior of OI throughout the first transition region 190 in FIG. 5B. An example of this effect is described in the context of FIG. 2.

In FIG. 5A, line 200 illustrates the variation of the temperature of OI as a function of position along the Y-axis. The horizontal dashed line 201 indicates the value of the temperature of the medium in the first reservoir 206 for reference. Line 202 illustrates the variation of the pressure of OI as a function of position along the Y-axis. The horizontal dashed line 203 indicates the value of the pressure of the medium in the first reservoir 206 for reference. Line 204 illustrates the variation of the density of OI as a function of position along the Y-axis. The horizontal dashed line 205 indicates the value of the density of the medium in the first reservoir 206 for reference.

The behavior of OI throughout the channel is similar to the behavior of OI in the exemplary embodiment shown in FIG. 1A. Note that the pressure 202 and the temperature 200 are larger in the second reservoir 207 than in the first reservoir 206 in this embodiment. This behavior is described in more detail with the aid of a simplified model in the context of FIG. 2.

To summarize, by suitably configuring the path taken by an OI throughout the force field produced by a force generating apparatus, the principles of the invention described in the context of FIG. 1A or FIG. 3A can be applied to other geometries.

FIG. 6A is a cross-sectional view of an exemplary embodiment of the invention.

FIG. 6A shows an electron filtering apparatus 230 configured to convert a low electrical voltage to a large electrical voltage, and vice versa. Filtering apparatus 230 can be referred to as a voltage conversion apparatus.

An electrical conductor 232 connects a first outside contact 231 via a first inside contact 233 with a first conductor 237. Electrical conductor 232 can be a conductor such as graphene, or a metal such as copper. In some embodiments, electrical conductor 232 can also be considered to be a superconductor. In FIG. 6A, electrical conductor 232 is shown as a bold line for simplicity, and can be considered to be an electrical wire. In some embodiments, electrical conductor 232 and first conductor 237 need not be distinguishable. In other words, electrical conductor 232 and first conductor 237 can be made of the same material, such as copper, and can have a substantially identical lengthwise cross-sectional area and geometry.

An electrical conductor 235 connects a second outside contact 234 via a second inside contact 236 with a fifth conductor 241. Electrical conductor 235 is configured in a similar manner as electrical conductor 232.

The electrons within electrical conductor 235 can be considered to be in a first reservoir 280. The electrons within electrical conductor 232 can be considered to be in a second reservoir 281. In the depicted embodiment, there is an open circuit between first outside contact 231 and second outside contact 234. The mobile electrons in the first and second reservoir can be considered to be the OI.

Filtering apparatus 230 comprises a central conductor 282 located between inside contact 233 and inside contact 236. Central conductor 282 comprises a first conductor 237, a second conductor 238, a third conductor 239, a fourth conductor 240, and a fifth conductor 241, where the conductors are separated by junctions 242, 246, 250, and 254. In this particular embodiment, the bulk material 259 of central conductor 282 is a doped semiconductor. Central conductor 282 is doped with both n-type and p-type dopants, as described in the context of FIG. 6B. In other embodiments, a junction can be between a metal and a metal, or a metal and a semiconductor.

Central conductor 282 has a rectangular cross-section when viewed along the horizontal direction, i.e. the direction parallel to the short portion of the page. In other embodiments, a central conductor 282 can have any cross-sectional geometry, such as a circular, square or polygonal cross-sectional geometry when viewed along the horizontal direction.

In some embodiments, central conductor 282 is a single piece of semiconductor, such as silicon or gallium arsenide, with variable levels of doping, as shown in FIG. 6B, along the horizontal length, i.e. the along the direction parallel to the short axis of the page. In such embodiment, first conductor 237, or second conductor 238 can also be referred to as a first conducting portion 237, or a second conducting portion 238, respectively. In some embodiments, central conductor 282 is manufactured by joining several individual pieces of semiconductor.

In other embodiments, central conductor 282 can comprise metals and different types of material or different types of semiconductor joined together in accordance with the principles of the invention outlined in the context of FIG. 6A and FIG. 6B. Note that in such embodiments the semiconductors need not be doped semiconductors, but can be different types or species of intrinsic semiconductor, i.e. semiconductors made of materials with a different Fermi levels.

The electrical conductor 232, the central conductor 282, and the electrical conductor 235 form a portion of an electric circuit, denoted the “conversion portion”. In the embodiment shown in FIG. 6A, this circuit is shown an open circuit for simplicity. In some embodiments, a separate electrical circuit, denoted the “load portion” can be connected in parallel to the conversion portion. The two terminals of the load portion can be connected to the two terminals of the conversion portion, i.e. to first outside contact 231 and second outside contact 234. For some embodiments, an electrical current can be made to flow through the conversion portion. For example, current can flow from the first outside contact 231, through electrical conductor 232, central conductor 282, and electrical conductor 235 to the first outside contact 234 during nominal operations, where nominal operation involves a steady current flow. To close the current loop, current also flows from second outside contact 234 through the load portion to the first outside contact 231 in this particular example. In some embodiments, at least a portion of the current flow is a result of a larger voltage at second outside contact 234 compared to first outside contact 231, where the larger voltage is a consequence of the configuration of the embodiment shown in FIG. 6A. In other words, the generic potential energy 272 of positive charges, or the voltage, at the second outside contact 234 can be larger than the generic potential energy of positive charges, or the voltage, at the first outside contact 231, resulting in an electron flow opposite to the conventional current flow through the load portion and the conversion portion.

The load portion can comprise any electrical device. For example, the load portion can comprise a conductor with a non-negligible resistivity. In some embodiments, the load portion can also be considered to comprise a single, conventional resistor. The load portion can also comprise electrical devices such as transistors, capacitors, or inductors. The load portion can also comprise an antenna configured to generate electromagnetic waves. The load portion can also comprise digital electronics, such as a microprocessor or computer. The load portion can also comprise an electric motor configured to do mechanical work. Note that electrical motors typically comprise heat exchangers in order to facilitate the flow of heat between the electrical conductors and the outside environment. In this manner, the conductors remain at a suitable temperature during nominal operations, where suitability is determined by the objective and the constraints of the particular application and the configuration of the embodiment. The load portion can comprise any electrical device capable of sustaining a voltage drop while a non-negligible current flows through the load portion. The load portion can comprise a light emitting diode.

FIG. 6B is a schematic plot of several physical properties as a function of position for the exemplary embodiment shown in FIG. 6A. Some features of the exemplary embodiment shown in FIG. 6A as well as some of the principles of operation of the exemplary embodiment share similarities with features and principles of operation described by the other figures, and FIG. 5A and FIG. 4A in particular, and will therefore not be described in the same detail in the context of FIG. 6A, and vice versa.

In each plot shown in FIG. 6B vertical axis indicates the value of a specified physical property, and the horizontal axis indicates the position along the Y-axis at which said physical property is measured, where the Y-axis is parallel to the short edge of the page and directed to the right hand side of the page.

Line 262 depicts the concentration of donor atoms embedded within semiconductor bulk material 259 at a given location along the Y-axis. The donor concentration 262 is the percentage of atoms in a silicon crystal which have been replaced by donor atoms. For a silicon semiconductor bulk material, a donor atom can be arsenic or phosphorus, for example.

Line 264 describes the concentration of acceptor atoms embedded within semiconductor bulk material 259 at a given location along the Y-axis. The acceptor concentration 264 is the percentage of atoms in a silicon crystal which have been replaced by acceptor impurities. For a silicon semiconductor bulk material, an acceptor atom can be boron, aluminium, or gallium, for example.

Line 266 shows the value of the electrical conductivity of the central conductor 282 as a function of position along the Y-axis. The conductivity changes as a result of a change in the concentration of mobile charge carriers, such as electrons or holes, within the central conductor 282.

Lines 268 illustrate the level of the isolated Fermi energy as a function of position along the Y-axis. The isolated Fermi energy is the Fermi energy for a hypothetical scenario in which each conductor portion, such as portion 237, portion 238, or portion 239 is electrically isolated from any other portion of central conductor 282. In other words, the Fermi energies 268 are the theoretical Fermi energies of the specified material when the material is considered in isolation, i.e. surrounded by a vacuum. The specified material is the material found in the central conductor 282 at the same position along the Y-axis indicated along the horizontal axis of the plot. For example, the Fermi energy in an isolated material configured identically to the material in second conductor 238 is smaller than the Fermi energy in an isolated material configured identically to the material in third conductor 239.

Lines 270 portray the average net charge density within central conductor 282.

Line 272 represents the value of the generic potential energy of a positive charge, such as a hole. Line 272 can also be considered to describe the voltage throughout the central conductor 282 for a static boundary condition. Note that an increase in the voltage is associated with a decrease in the generic potential energy of a negative charge, such as an electron.

In the following paragraphs, the voltage difference between the first outside contact 231 and the second outside contact 234 will be explained. For simplicity, the conversion portion is an open circuit throughout this explanation, i.e. there is no current flow through the conversion portion. Due to the open circuit, the first reservoir 280 and second reservoir 281 can be considered to be subject to a static boundary condition. Note that, in the case in which current flows from second outside contact 234 to first outside contact 231 through the load portion, there is typically a decrease in the magnitude of the voltage difference between the second outside contact 234 and the first outside contact 231 compared to the open circuit scenario shown in FIG. 6A. This decrease is due to a voltage drop within the conversion portion, which can arise from the internal resistance of the conductors within the conversion portion and the current flowing through the conversion portion, for example.

Due to the lower isolated Fermi energy 268 in the fourth conductor 240 compared to the fifth conductor 241, negative charges will move from the fifth conductor to the fourth conductor 240. The difference in the isolated Fermi energies at a junction between two conductors can be provided by configuring the material of the fourth conductor 240 differently to the material of the fifth conductor 241. For example, one material can be a metal, and another material can be a semiconductor. In another example, the difference in the isolated Fermi energy can be a result of a difference in the level of doping between the two conductors, as is the case in FIG. 6B. More specifically, fifth conductor 241 can be considered an n-type semiconductor and the fourth conductor 240 can be considered a p-type semiconductor. In other words, in the fifth conductor 241, the concentration of donor atoms 262 is larger than the concentration of acceptor atoms 264. Similarly, in the fourth conductor 240, the concentration of donor atoms 262 is smaller than the concentration of acceptor atoms 264. Junction 254 can be considered to be a conventional semiconductor pn junction in a subset of embodiments. The isolated Fermi energy is larger in the fifth conductor 241 than in the fourth conductor 240. As a result, electrons will diffuse from the fifth conductor 241 to the fourth conductor 240. This diffusion will result in a surplus of negative charges in the fourth conductor 240 and a surplus of positive charges in the fifth conductor 241. Since these charges attract, they will accumulate in the vicinity of the junction 254 between the fourth conductor 240 and the fifth conductor 241, resulting in a negative collection of charge 255 in the fourth conductor 240 and a positive collection of charge 256 in the fifth conductor 241, as shown. These collections of charge will give rise to an electric field directed in the negative Y-direction across the junction 254. The field will produce a drift current of electrons and holes across the junction 254 which is directed in the opposite direction of the diffusion current. In the open circuit configuration shown, the diffusion current is equal and opposite to the drift current, resulting in no net current flow for the static boundary condition. The electric field associated with the collections of charge will give rise to an increase in the voltage 272 in the positive Y-direction across the junction 254. This increase in the voltage occurs within a first transition region 275, which ranges throughout charge collection 255 and charge collection 256. In conventional models of pn junctions in semiconductors, such as junction 254, the electrons are considered to behave in the same way as an isothermal ideal gas being expanded or compressed. Electrons diffusing in the negative Y-direction through junction 254 can be considered to be compressed isothermally and ideally, and electrons diffusing in the positive Y-direction through junction 254 can be considered to be expanded isothermally and ideally, where “ideally” refers to an ideal gas behavior. Such models also typically assume the behavior of the electrons and holes can be approximated by the Maxwell-Boltzmann distribution. As mentioned, this behavior is called the Boltzmann tail of the Fermi-Dirac distribution, which more generally describes the behavior of electrons in solids. In other models, the electrons can be considered to also experience a change in temperature throughout their diffusion through first transition region 275. In some embodiments, the electrons can be considered to be expanded or compressed adiabatically when diffusing in the positive or negative Y-direction, respectively, through first transition region 275.

The region occupied by charge collection 255 and charge collection 256 is also referred to as a “depletion region”. This is due to the depletion of mobile charge carriers, such as holes and electrons. In charge collection 255 there are negatively charged, i.e. ionized, acceptor atoms in fourth conductor 240, and in charge collection 256 there are positively charged, i.e. ionized, donor atoms in fifth conductor 241. These ions are embedded within bulk material 259 of central conductor 282.

The configuration of the other conductors within central conductor 282, and the junctions between them, follows the same principles described in the context of fourth conductor 240 and fifth conductor 241.

First conductor 237 can be considered an n-type semiconductor and second conductor 238 can be considered a p-type semiconductor. In other words, in the first conductor 237, the concentration of donor atoms 262 is larger than the concentration of acceptor atoms 264. Similarly, in the second conductor 238, the concentration of donor atoms 262 is smaller than the concentration of acceptor atoms 264. The isolated Fermi energy 268 is larger in the first conductor 237 than in the second conductor 238. This leads to a positive collection of charge 243 within first conductor 237 at junction 242, and a negative collection of charge 244 within second conductor 238 at junction 242, as shown.

Third conductor 239 can be considered to be an n-type semiconductor. In the third conductor 239, the concentration of donor atoms 262 is larger than the concentration of acceptor atoms 264. The isolated Fermi energy 268 is larger in the third conductor 239 compared to the second conductor 238 and compared to the fourth conductor 240. This leads to a positive collection of charge 248 within third conductor 239 at junction 246, and a negative collection of charge 247 within second conductor 238 at junction 246, as shown. This also leads to a positive collection of charge 251 within third conductor 239 at junction 250, and a negative collection of charge 252 within fourth conductor 240 at junction 250, as shown. Junctions 242, 246, 250, and 254 can be considered to be semiconductor pn junctions due to the discontinuity in the donor and acceptor carrier concentrations across the junctions. Note that the behavior of electrons and holes across junctions of the central conductor 282 does not in general follow the behavior in conventional junctions. For instance, for the exemplary embodiment shown in FIG. 6A, the behavior of charge carrier across junctions 242 and 250 deviates from the conventional behavior.

The charge density 270 within a collection of charge, such as charge collection 247, is approximately constant throughout a collection of charge for the embodiment shown in FIG. 6A. In other embodiments, or in more accurate models, the distribution of charge along the Y-direction in depletion regions in metals need not be rectangular in shape along the Y-axis. For example, it can be exponential in shape along the Y-axis. This can be the case in which a conductor within central conductor 282, such as second conductor 238, is a metal rather than a semiconductor. For example, if first conductor 237 is a metal with a higher isolated Fermi energy than second conductor 238, the concentration of positive charges in charge collection 243 can increase at an increasing rate in the first conductor 237 at junction 242. As mentioned, in the exemplary embodiment shown, the concentration of positive charges in charge collection 243 is approximately constant in the first conductor 237 at junction 242, as indicated by line 270 in FIG. 6B.

The region of a conductor between charge collections is denoted the “neutral region”. Within second conductor 238 the concentration of donor atoms 262 and the concentration of acceptor atoms 264 decreases in the positive Y-direction in the neutral region. The change in the concentration of donor atoms 262 is matched by a corresponding change in the concentration of acceptor atoms 264 in manner in which the concentration of holes in the valence band, “p”, of second conductor 238 is substantially unchanged. For example, the difference in the concentration of acceptor atoms 264 and the concentration of donor atoms 262 can remain constant throughout the reduction in the concentration of acceptor atoms 264 in the neutral region of second conductor 238. Note that the concentration of electrons in the conduction band, “n”, also remains unchanged in such embodiments, since the intrinsic concentration of electrons in the conduction band, “ni”, also remains unchanged throughout semiconductor 259 in the depicted embodiment 230. The reduction in the concentration of donor atoms 262 and acceptor atoms 264 in the positive Y-direction is associated with a reduction in the conductivity 266 in the positive Y-direction in second conductor 238. In other embodiments, the concentration of holes in the valence band can change along the Y-direction throughout a neutral region.

Within the neutral region of third conductor 239, the concentration of donor atoms 262 and the concentration of acceptor atoms 264 increases in the positive Y-direction in a manner in which the concentration of electrons in the conduction band, n, remains substantially constant. This is associated with an increase in the conductivity 266 in the positive Y-direction in third conductor 239. The neutral regions of fourth conductor 240 and fifth conductor 241 are configured in a similar manner as the neutral regions in second conductor 238 and third conductor 239.

Note that the region which lies between the end of the neutral region of the first conductor 237 and the end of the neutral region of the third conductor 239 along the positive Y-direction can be considered to be a voltage conversion apparatus. Similarly, the region which lies between the end of the neutral region of the third conductor 239 and the end of the neutral region of the fifth conductor 241 along the positive Y-direction can be considered to be a voltage conversion apparatus. Central conductor 282 can thus be considered to comprise two voltage conversion apparatuses connected in series. In other embodiments, a central conductor can comprise a single voltage conversion apparatus. In other embodiments, central conductor can comprise more than two voltage conversion apparatuses connected in series. In some embodiments, voltage conversion apparatuses can be connected in parallel.

The conductivity throughout a depletion region and a junction is assumed to remain constant in the simplified model described in FIG. 6B. The reduction in the conductivity due to a reduction in the concentration of donor atoms 262 across junction 242 in the positive Y-direction is offset by an increase in the conductivity due to the increase in the concentration of acceptor atoms 264. In some embodiments, the larger drift mobility of electrons results in a larger conductivity in an n-type semiconductor compared to a p-type semiconductor in the case in which the concentration of holes in the valence band is in the p-type semiconductor is equal to the concentration of electrons in the conduction band of the n-type semiconductor. In some embodiments, the conductivity across a junction is not constant. In some embodiments, the concentration of charge carriers, such as mobile holes or electrons, is not constant across a junction.

The width of a depletion region, i.e. the extent of a depletion region along the Y-direction, is a function of the concentration of acceptor and donor atoms. The larger the concentration of donor and acceptor atoms, the smaller the depletion region. For example, the concentration of donor atoms 262 and the concentration of acceptor atoms 264 in the vicinity of junction 254 is smaller compared to junction 250. Therefore, the width of the depletion region of junction 254 is larger than the width of the depletion region at junction 250. In other embodiments, such as embodiments in which at least one conductor at a junction is a metal, the thickness of the depletion region can be a function of the electrical conductivity. A large conductivity is typically associated with a small depletion region, and a small conductivity is associated with a large depletion region in a particular conductor. Therefore, the width of a depletion region can be configured by selecting associated materials with an appropriate conductivity, or an appropriate concentration of donor or acceptor atoms, for example. The width of neighboring depletion regions can be modified by modifying the electrical conductivity or the concentration of donor or acceptor atoms. The conductivity of metals can be modified by inserting impurities within a conductor, for example. The impurities can comprise insulating material such as glass, ceramic, or semiconducting material such as silicon, or conducting material with a lower or a higher electrical conductivity than the original material.

The voltage 272, or the generic potential energy of a hypothetical positive charge, throughout central conductor 282 is shown in FIG. 6B. Consider a positively charged test OI diffusing from the second reservoir 281 through central conductor 282 to the first reservoir 280.

In the second reservoir 282, i.e. in electrical conductor 232, the voltage 272 is substantially constant, as indicated by constant region 279. Similarly, the voltage in the first reservoir 280 is substantially constant, as indicated by constant region 274. Within a neutral region, such as the neutral region of third conductor 239, the voltage is also substantially constant, as indicated by constant region 278. The generic potential energy in the neutral region of fourth conductor 240 is also substantially constant, as indicated by constant region 276.

As the test OI enters a depletion region, the test OI encounters an electric field with a non-zero component along the positive or negative Y-direction. The associated force acting on the OI changes the generic potential energy of the OI as it moves along the Y-direction. When the electric field has a non-zero component in the positive Y-direction, such as the electric field at junction 250, the positive test OI experiences a force in the positive Y-direction, resulting in a decrease in the generic potential energy throughout the depletion region in the positive Y-direction. The depletion region consisting of collections of charge 251 and 252 is also referred to as second transition region 277. Similarly, when the electric field has a non-zero component in the negative Y-direction, such as the electric field at junction 254, the positive test OI experiences a force in the negative Y-direction, resulting in an increase in the generic potential energy throughout the depletion region in the positive Y-direction. The depletion region consisting of collections of charge 255 and 256 is also referred to as first transition region 275.

As mentioned, for simplicity, the behavior of the mobile charges, such as holes or electrons, in first transition region 275 can be considered to be described by the conventional model for a pn junction of a semiconductor. The difference in the isolated Fermi energies of the fourth conductor 240 and the fifth conductor 241 can be used to calculate the magnitude of the voltage difference between constant region 274 and constant region 276. This voltage difference is also known as the “built-in potential”. The built in potential can be considered to be required to equalize the Fermi energies across junction 254 for the static boundary condition. The width of the depletion region, i.e. the sum of the extent of collection of charge 255 and collection of charge 256 along the Y-direction, can be calculated from the voltage difference in the first transition region 275, i.e. the built-in potential. The width of the depletion region is also a function of the given concentration of donor atoms 262 and the concentration of acceptor atoms 264 in each conductor, amongst other parameters. Similarly, the total number of negative charges in charge collection 255, and the total number of positive charges in charge collection 256, is determined by the built-in potential. The number of charges in a collection of charge are also a function of the concentration of donor and acceptor atom on both sides of the junction, amongst other parameters. Thus, the material properties of fourth conductor 240 and fifth conductor 241 can be chosen or configured to provide a desired average gradient in the generic potential energy of a positive test OI throughout first transition region 275. Note that the average gradient is the ratio of the built-in potential and the width of the depletion region.

In accordance with some embodiments of the invention, second transition region 277 is configured in a manner in which the width of transition region 277 is sufficiently small, such that the behavior of OI across second transition region 277 deviates from the behavior of OI in a baseline or reference scenario, which, in this case, is the behavior of OI in a conventional pn junction. The width of a transition region, such as transition region 277, is the extent of the transition region 277 along the path of OI diffusing through the transition region, such as along the Y-axis in the case of transition region 277. This can be accomplished by configuring the width of the second transition region 277 to be smaller than several orders of magnitude larger than the smallest mean free path of OI in a constant region adjacent to transition region 277. For instance, the width of second transition region 277 can be on the order of the mean free path of mobile electrons in constant region 276. Second transition region 277 can be configured in a similar manner as second transition region 7 in FIG. 1A, and the second transition region described in the context of FIG. 2. The behavior of OI throughout second transition region 277 compared to first transition region 275 follows principles similar to those outlined in the context of FIG. 1A and FIG. 2. The holes or electrons diffusing in the positive or negative Y-direction through second transition region 277 experience a reduced number of collisions per unit change in generic potential energy compared to the baseline scenario. This changes the behavior of OI through transition region 277 compared to transition region 275. The behavior of OI through transition region 277 thus deviates from the behavior of electrons or holes across a conventional semiconductor pn junction. As a result, the difference in the voltage 272 between constant region 278 and constant region 276 is smaller than the difference in the voltage 272 between constant region 274 and constant region 276. As mentioned in the context of FIG. 2, in other embodiments, the former difference can be larger than the latter. This can be the case when the difference in the isolated Fermi energy between the conductors at a junction is much larger than the difference in the embodiment described in FIG. 6B, for example.

In a highly simplified example, consider the positive test OI diffusing in the positive Y-direction through transition region 277 without experiencing a collision. Prior to moving through the second transition region 277, the energy of any OI is assumed to be distributed according to the Maxwell-Boltzmann distribution in this simplified model. A lack of collisions, or a reduced number of collisions per unit change in generic potential energy, in the second transition region 277 can change in the distribution of energy of an electron or hole moving through the second transition region 277 in a manner in which the distribution deviates from a baseline, reference, or conventional distribution. Following the movement through a transition region, the OI will experience collisions, resulting in a redistribution of energy of the OI. Following the redistribution process, the type of distribution of energy of the electrons returns to the conventional type of distribution, which, in this case, is the Maxwell-Boltzmann distribution, which also describes the behavior of an ideal gas. In the simplified model, this redistribution occurs in a constant region, such as constant region 278 or constant region 276. Note that this simplified example is identical to the simplified example discussed in more detail in the context of FIG. 2. The behavior of OI throughout the second transition region 277 can therefore not be modelled as an isothermal, ideal gas compression or expansion of the medium containing OI, which is how the behavior of OI throughout first transition region 275 is modelled conventionally.

By contrast, due to the large width of the first transition region 275, the OI moving through the first transition region 275 experience multiple collisions throughout first transition region 275, resulting in a more frequent redistribution of energy of the OI throughout first transition region 275 per unit change in generic potential energy. A collision can occur with an atom or molecule in a conductor, i.e. with a phonon or a lattice vibration. A collision can also occur between a hole and an electron, which is also known as a recombination or generation. A collision can also occur between holes or between electrons. These collisions throughout first transition region 275 maintain the conventional distribution of energy among the states of an OI, which, in this case, is the Maxwell-Boltzmann distribution. The collisions between OI and phonons, i.e. the molecules in the conductors, allow the transfer of heat between the OI and the fourth conductor 240 and the fifth conductor 241. This contributes to the isothermal behavior of OI throughout first transition region 275.

As mentioned in the context of FIG. 2, the aforementioned example is highly simplified, and not intended to limit the scope of the invention. Other embodiments need not exhibit the same behavior or the same features as described in the aforementioned example. For instance, the behavior of OI within first transition region 275 can also deviate from the behavior of OI in the conventional model for a semiconductor pn junction. In such embodiments, the deviation from the conventional behavior can be larger in the second transition region 277 than in the first transition region 275. This can maintain the voltage conversion functionality of central conductor 282.

The width of the depletion region at junction 250, i.e. the width of the second transition region 277, is a function of the aforementioned behavior of OI throughout the second transition region 277 as well as the material properties of the third conductor 239 and fourth conductor 240, amongst other parameters. In this particular example, the voltage difference throughout second transition region 277 is less than the conventionally calculated built-in voltage for a pn junction.

In a more detailed example, consider a scenario in which the smallest mean free path of mobile electrons in the proximity of second transition region 277 is 40 nanometers. In this scenario, the width of second transition region 277 can be configured to be less than 10 nanometers, and the width of first transition region 275 can be configured to be 1 micrometers. The temperature of the second conductor 282 can be room temperature.

Note that, the behavior of OI throughout second transition region 277 can also be isothermal in some embodiments and some configurations. In such embodiments, the behavior of OI throughout second transition region 277 nevertheless deviates from the isothermal behavior of an ideal gas compression or expansion, or the isothermal behavior throughout first transition region 275. The discrepancy can manifest itself in the change in the density or pressure of OI throughout a transition region, for example.

In general, the behavior of the OI throughout a second transition region configured in accordance with the invention deviates from the behavior of OI throughout a suitable theoretical reference scenario, or a comparable first transition region. By default, the reference scenario is a scenario involving a standard distribution, such as the Fermi-Dirac distribution, the Maxwell-Boltzmann distribution, or the Bose-Einstein distribution.

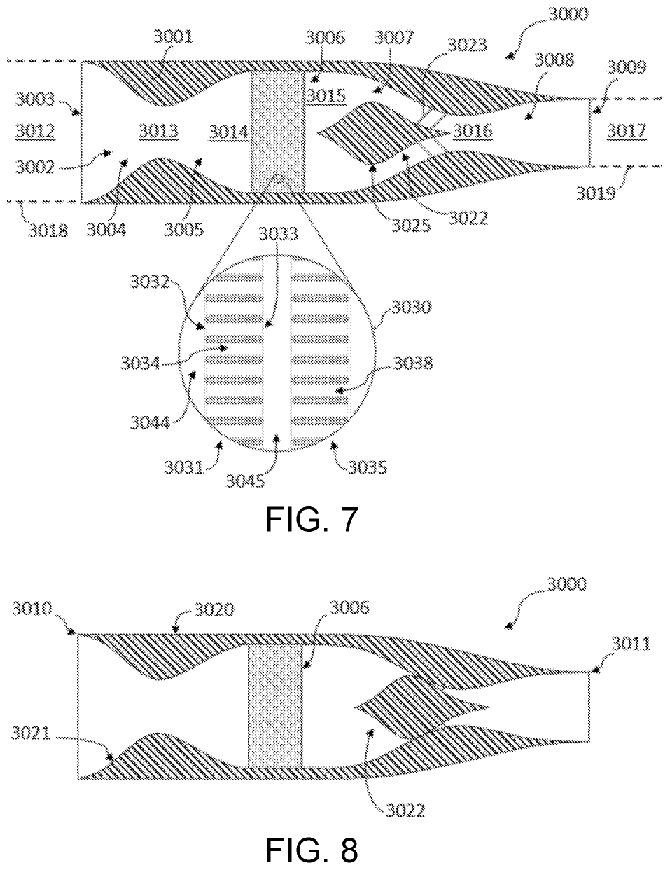

FIG. 7 is a cross-sectional view of an application of an embodiment of the invention in a supersonic ramjet engine.

Engine 3000 can be employed to produce thrust by interacting with gas molecules, such as air molecules, for example. Engine 3000 comprises a first inlet 3003, a first contraction 3004, a first expansion 3005, a filtering apparatus 3006, a second contraction 3007, a second expansion 3008 and an exit 3009. During nominal, supersonic flight, an inflow streamtube 3018 and an outflow streamtube 3019 is incident on or emitted by stagnation points of the leading edge 3010 and trailing edge 3011, respectively.

Engine 3000 comprises a channel 3002 bounded by bulk material 3001 and located between inlet 3003 and outlet 3009. Engine 3000 can be configured to operate in air, for example. The exterior surface 3020 and the interior surface 3021 of the engine describe axially symmetric and concentric surfaces in this simplified embodiment, with the axis of symmetry being parallel to the X-axis, which is parallel to the bottom of the page, and with the axis of symmetry being referred to as the “central axis”.

A translating spike 3022 with external surface 3025 is configured to regulate the flow rate through the engine 3000 and thus regulate the amount of thrust produced. The translating spike 3022 can be moved by hydraulic or electric actuators along the central axis to increase or reduce the cross-sectional area of the channel 3002 from an open position to a closed position in a continuously variable fashion. Support struts, such as support strut 3023 provide structural support to the translating spike. The flow direction during nominal operation is from the left of the page to the right of the page, in the positive X-direction.

Filtering apparatus 3006 is configured in accordance with one embodiment. For example, filtering apparatus 3006 can comprise several layers of filtering apparatuses, such as layer 3031 and layer 3035 arranged in series, where each filtering apparatus in a layer is arranged in a similar manner as the filtering apparatus shown in FIG. 3A. Accordingly, the density of the medium comprising the objects of interest, e.g. the air, is increased across the filtering apparatus, such that the density at station 3015 is larger than the density at station 3014. Similarly, the density at station 3045 is larger than at station 3044. In this particular example, the temperature and pressure at station 3015 are smaller than at station 3014, as indicated by FIG. 3B and FIG. 2. Note that the second transition region is located downstream of the first transition region in this particular example. In other examples, such as the case in which the gas is isothermal throughout the filtering apparatus 3006, the pressure at station 3015 is larger than at station 3014. The isothermal case is illustrated by the intersection of line 34 and line 35 in FIG. 2.

A wide variety of alternate cases are described by FIG. 2, such as a case in which the temperature and pressure at station 3015 is larger than at station 3014. Note that, in some such embodiments, the second transition region is located upstream of the first transition region, as opposed to downstream of the first transition region, in order to produce a net thrust or to allow the OI to do a net amount of work. These cases occur when the depth of the generic potential well exceeds a threshold value. In FIG. 2, this threshold value occurs at a depth in the generic potential well which is slightly larger or deeper than the depth of the isothermal case. The threshold depth can be calculated by determining at which depth the specific entropy of OI diffusing through the potential well from the first transition region to and through the second transition region increases instead of decreasing. For potential wells which are shallower than the threshold depth, the second transition region can be located downstream of the first transition region. For potential wells which are deeper than the threshold depth, the second transition region can be located upstream of the first transition region. This ensures that the specific entropy of OI always decreases for OI flowing through the potential well. The entropy decrease can allow the OI to do a net amount of work, and absorb an equivalent net amount of energy from the environment.

There is a net diffusion of OI, e.g. air molecules, through the filtering apparatus 3006 in the positive X-direction. Each channel system in a filter apparatus comprises a first opening, such as a first opening 3032 and a second opening 3033 of a channel, such as channel 3034, or channel 3038, as shown by enlargement 3030.

Engine 3000 can be considered to operate in a similar fashion as a conventional ramjet in other aspects. Between the free stream station 3012 and the throat 3013 supersonic flow is decelerated and the air is compressed preferably isentropically, i.e. without the production of shock waves. Between throat 3013 and station 3014 the flow is compressed and decelerated further to subsonic flow speeds. This compression between station 3012 and 3014 in an ideal ramjet is adiabatic, but in practical implementations there can be a weak shock wave stabilized between throat 3013 and station 3014, preferably close to throat 3013 to reduce losses. The flow velocity at station 3014 is reduced in order to reduce the drag associated with the filtering apparatus 3006.

The filtering apparatus is configured to increase the density of the gas and reduce the specific entropy of the gas. Following the increase in density at station 3015, the gas is expanded, preferably adiabatically, through a convergent and divergent nozzle. In this expansion the temperature of the gas is reduced, such that the temperature at station 3017 is less than the temperature at station 3012, while the pressures at both stations are atmospheric pressures.

In other embodiments, the individual layers in a filtering apparatus can be configured in a similar manner as the filtering apparatus shown in FIG. 4A, or FIG. 5A, or FIG. 1A. In some embodiments, a filtering apparatus can comprise several periodic arrangements of layers of filtering apparatuses. The filtering apparatuses within a layer are arranged in parallel fashion, while the filtering apparatuses in adjacent layers are arranged in series.

The “characteristic length” is the length of the second transition region, such as length “L2” in FIG. 5A, or the extent of the second transition region 81 in FIG. 3A along the Y-axis, or the length of second transition region 7 in FIG. 1A projected onto the Y-axis, or the extent of second transition region 146 in FIG. 4A along the Y-axis. In some embodiments, the characteristic length is smaller than 1000 times the smallest mean free path of objects of interest adjacent to the second transition region. The characteristic length is smaller than 100 times the smallest mean free path of objects of interest adjacent to the second transition region in some embodiments. The characteristic length is smaller than 10 times the smallest mean free path of objects of interest adjacent to the second transition region in some embodiments. The characteristic length is smaller than the smallest mean free path of objects of interest adjacent to the second transition region in some embodiments.

In some embodiments, the characteristic length of each layer of filtering apparatuses can be reduced in a downstream direction throughout a combined filtering apparatus in correspondence with a reduction in the mean free path associated with an increase in density across a filtering apparatus. Alternatively the flow velocity can be increased and the density of the medium can be decreased in order to maintain the length of the mean free path above a size constraint provided by the configuration or manufacturability of the filtering apparatus.

FIG. 8 is a cross-sectional view of the embodiment shown in FIG. 7 in a closed or zero-thrust configuration. In this configuration the translating spike 3022 is in a fully retracted position, resulting in a closing off of the channel 3002 and the production of zero thrust. The filtering apparatus 3006 can be considered to operate at a static boundary condition in this configuration, with a larger density being produced in the second reservoir at station 3015 compared to the first reservoir at station 3014 in this particular scenario. The translating spike 3022 can be employed to regulate or control the amount of thrust produced by controlling the mass flow rate of a fluid through channel 3002 of the engine.

In other embodiments, the thrust can be regulated by modifying the amount of charge within a collection of charge, such as collection of charge 117 in FIG. 4A, or collection of charge 56 in FIG. 3A. The amount of charge can be regulated by a voltage source connected to the individual charge collections via electrical conductors. The voltage source can be a battery, or an electrical generator, for instance.

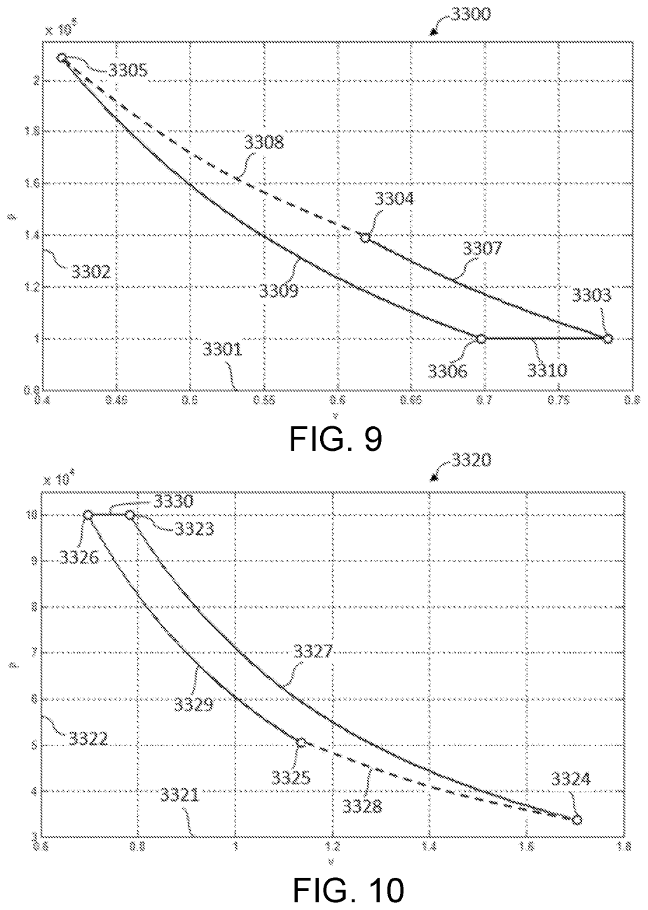

FIG. 9 is a plot of the value of pressure 3302 versus specific volume 3301 of air which passes through an example embodiment of the invention, such as an embodiment configured similarly to the example embodiment shown in FIG. 1A, FIG. 3A, FIG. 4A, or FIG. 5A. For simplicity, the plot shows an isothermal scenario. The isothermal case is illustrated by the intersection of line 34 and line 35 in FIG. 2.

The thermodynamic cycle in plot 3300 shows a first point 3303, a second point 3304, a third point 3305, and a fourth point 3306. The fifth point and the first point are coincident. A gas at free stream condition 3303 is compressed adiabatically 3307. During the encounter with a filtering apparatus configured in accordance with one embodiment, the gas is compressed isothermally and adiabatically, as shown by dashed line 3308. In the process, the specific entropy of the gas is reduced. The gas is subsequently expanded adiabatically 3309. At station 3306, the gas is expelled into the free stream at free stream pressure. In the free stream the gas is heated isobarically 3310. The gas at station 3306 is colder than at station 3303, and the net mechanical work produced by the cooling of the gas is the difference in the work of adiabatic expansion 3309 and adiabatic compression 3307.

Stations 3303, 3304, 3305, and 3306 can be considered to correspond to stations 3012, 3014, 3015, and 3017, respectively, in FIG. 7 for a subset of embodiments. Other thermodynamic cycles, such as closed cycles or cycles involving isochoric or isothermal compression or expansion as opposed to adiabatic compression or expansion, employing filtering apparatuses configured in accordance with embodiments of the invention can be readily constructed by those skilled in the art. The values of the pressures for this cycle are arbitrary and chosen for illustrative purposes, and are not intended to limit the scope of the invention.

FIG. 10 is a plot of the value of pressure 3322 versus specific volume 3321 of air which passes through an example embodiment of the invention, such as an embodiment configured similarly to the example embodiment shown in FIG. 1A, FIG. 3A, FIG. 4A, or FIG. 5A. For simplicity, the plot shows an isothermal scenario. The isothermal case is illustrated by the intersection of line 34 and line 35 in FIG. 2.

The thermodynamic cycle in plot 3320 shows a first point 3323, a second point 3324, a third point 3325, and a fourth point 3326. The fifth point and the first point are coincident. A gas at free stream condition 3323 is expanded adiabatically 3327. During the encounter with a filtering apparatus configured in accordance one embodiment, the gas is compressed isothermally and adiabatically, as shown by dashed line 3328. In the process, the specific entropy of the gas is reduced. The gas is subsequently compressed adiabatically 3329. At station 3326, the gas is expelled into the free stream at free stream pressure. In the free stream the gas is heated isobarically 3310. The gas at station 3326 is colder than at station 3323, and the net mechanical work produced by the cooling of the gas is the difference in the work of adiabatic expansion 3327 and adiabatic compression 3329.

Other thermodynamic cycles, such as closed cycles or cycles involving isochoric or isothermal compression or expansion as opposed to adiabatic compression or expansion, employing filtering apparatuses configured in accordance with various embodiments of the invention can be readily constructed by those skilled in the art. The values of the pressures for this cycle are arbitrary and chosen for illustrative purposes, and are not intended to limit the scope of the invention.

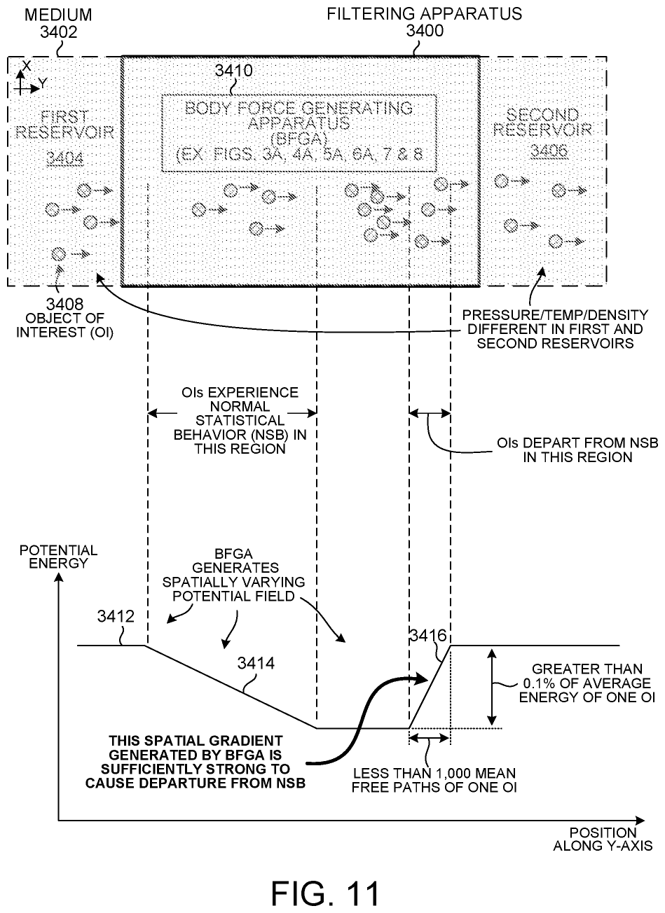

FIG. 11 is a diagram that shows another embodiment of a filtering apparatus 3400 in accordance with various embodiments. The filtering apparatus 3400 is disposed within a medium 3402. The filtering apparatus 3400 facilitates diffusion of objects of interest from a first reservoir 3404 to a second reservoir 3406 without consuming useful energy, such as fuel or electrical energy stored in a battery. Reference numeral 3408 identifies one such object of interest. The filtering apparatus includes a Body Force Generating Apparatus (BFGA) 3410. The BFGA 3410 applies a body force per unit mass on objects of interest 3408. Objects of interest include air molecules, water molecules, dust particles, ions, electrons, and other types of elementary particles or constituent parts within a medium. The force field generated by the BFGA 3410 gives rise to a spatially varying potential field 3412. In this example, the spatially varying potential field 3412 includes a first gradient 3414 and a second gradient 3416. The first gradient 3414 causes the objects of interest to experience normal statistical behavior. The second gradient 3416 is sufficiently strong to cause the objects of interest to depart from normal statistical behavior. Various examples of BFGAs, such as BFGA 3410, that give rise to a spatial or temporal gradient sufficiently strong to cause the objects of interest to depart from normal statistical behavior, such as gradient 3416, are shown in FIGS. 3A, 4A, 5A, 6A, 7 and 8.

Unless specified or clear from context, the term “or” is equivalent to “and/or” throughout this description.

Various embodiments of the invention further comprise the following aspects.

Aspect 1. A filtration apparatus, the filtration apparatus comprising: a body force generating apparatus, or BFGA, configured to apply a body force per unit mass on objects of interest in a medium, wherein the force field generated by the BFGA gives rise to a spatially varying potential energy of objects of interest, i.e. a spatially varying potential field, wherein the spatial or temporal gradient of the potential field is sufficiently strong at at least one location in space or at least one instant in time, such that the objects of interest experience a departure from normal statistical behavior within that field, wherein the potential gradient is larger than the ratio of 0.1% of the average energy of an object of interest over the length of 1000 mean free paths, or 1000 mean free times of an object of interest adjacent to the potential gradient.

Aspect 2. A filtration apparatus of aspect 1, wherein the objects of interests are air molecules.

Aspect 3. A filtration apparatus of aspect 1, wherein the objects of interests are water molecules.

Aspect 4. A filtration apparatus of aspect 1, wherein the objects of interests are dust particles, ions, electrons, and other types of elementary particles or constituent parts within a medium.

Aspect 5. A filtration apparatus of aspect 1, wherein the body force is gravitational in nature.

Aspect 6. A filtration apparatus of aspect 1, wherein the body force is inertial in nature.

Aspect 7. A filtration apparatus of aspect 1, wherein the body force is electrical in nature.

Aspect 8. A filtration apparatus of aspect 1, wherein the body force is magnetic in nature.

Aspect 9. A filtration apparatus of aspect 1, wherein the body force is electromagnetic in nature.

Aspect 10. A filtration apparatus of aspect 1, wherein normal statistical behavior is described by Maxwell-Boltzmann statistics.

Aspect 11. A filtration apparatus of aspect 1, wherein normal statistical behavior is described by Fermi-Dirac statistics.

Aspect 12. A filtration apparatus of aspect 1, wherein normal statistical behavior is described by Bose-Einstein statistics.

Aspect 13. A filtration apparatus of aspect 1, wherein the potential field in the immediate proximity of the sufficiently strong potential field of aspect 1 is stronger, i.e. of a spatially or temporally larger potential field gradient magnitude, or smaller, i.e. of a spatially or temporally smaller potential field gradient magnitude, relative to the sufficiently strong potential field of aspect 1.

Aspect 14. A filtration apparatus of aspect 13, wherein there is a net flow of objects of interest through the spatially or temporally asymmetric potential fields for a dynamic boundary condition.

Aspect 15. A filtration apparatus of aspect 13, wherein there is a net change in the concentration or density of objects of interest on one side of the asymmetric potential fields compared to another side for a static boundary condition.

Aspect 16. A filtration apparatus of aspect 13, wherein there is a net change in the temperature of objects of interest on one side of the asymmetric potential fields compared to another side for a static boundary condition.

Aspect 17. A filtration apparatus of aspect 13, wherein there is a net change in the pressure of objects of interest on one side of the asymmetric potential fields compared to another side for a static boundary condition.

Aspect 18. A filtration apparatus of aspect 7, wherein the objects of interest carry an induced or permanent electric dipole.

Aspect 19. A filtration apparatus of aspect 8, wherein the objects of interest carry an induced or permanent magnetic dipole.

Aspect 20. A filtration apparatus of aspect 7, wherein the objects of interest carry an induced or permanent electric charge.

Aspect 21. A filtration apparatus of aspect 7, wherein the BFGA comprises charges embedded in insulating material.

Aspect 22. A filtration apparatus of aspect 7, wherein the medium comprises a conducting or semiconducting material.

Aspect 23. A filtration apparatus of aspect 1, wherein the body force is substantially uniform in direction and magnitude in space, and wherein the asymmetric spatial gradient experienced by objects of interests is provided by the asymmetric shape of a channel or pipe through the force field.

Aspect 24. A filtration apparatus of aspect 1, wherein the filtration apparatus also comprises at least one channel through which objects of interest can diffuse and within which the objects can be subjected to a spatially or temporally varying potential field.

Aspect 25. A system comprising at least two filtration apparatuses of aspect 1, wherein each filtration apparatus is connected in series, such that objects of interest can diffuse through them sequentially.

Aspect 26. A system comprising at least two filtration apparatuses of aspect 1, wherein the filtration apparatuses are arranged in parallel to each other.

Aspect 27. A method of filtering, pumping, or changing the concentration of objects of interest, the method comprising: providing a body force generating apparatus, or BFGA, configured to apply a body force per unit mass on objects of interest in a medium, wherein the force field generated by the BFGA gives rise to a spatially varying potential energy of objects of interest, i.e. a spatially varying potential field, wherein the spatial or temporal gradient of the potential field is sufficiently strong at at least one location in space or at least one instant in time, such that the objects of interest experience a departure from normal statistical behavior within that field, wherein the potential gradient is larger than the ratio of 0.1% of the average energy of an object of interest over the length of 1000 mean free paths, or 1000 mean free times of an object of interest adjacent to the potential gradient.

Aspect 28. A method of filtering, pumping, or changing the concentration of objects of interest, the method comprising: providing any one of aspects 1-26.

Although certain specific exemplary embodiments are described above in order to illustrate the invention, the invention is not limited to the specific embodiments. Accordingly, various modifications, adaptations, and combinations of various features of the described embodiments can be practiced without departing from the scope of the invention as set forth in the claims.

What is claimed is:

1. An apparatus comprising:
a Body Force Generating Apparatus (BFGA) that applies a body force per unit mass on objects of interest in a medium, wherein a spatially varying potential field generated by the BFGA causes the objects of interest to have spatially varying potential energy, and wherein a spatial or temporal gradient of the spatially varying potential field is sufficiently strong at at least one location in space or at at least one instant in time such that the objects of interest experience a departure from normal statistical behavior within the spatially varying potential field.

2. The apparatus of claim 1, wherein the spatial or temporal gradient is larger than a ratio of 0.1% of an average energy of one of the objects of interest over the length of 1000 mean free paths, or larger than 1000 mean free times of one of the objects of interest adjacent to the spatial or temporal gradient.

3. The apparatus of claim 1, wherein the objects of interests comprise at least one object selected from the group consisting of: air molecules, water molecules, dust particles, ions, electrons, and other types of elementary particles or constituent parts within the medium.

4. The apparatus of claim 1, wherein the body force is a force selected from the group consisting of: a gravitational force, an inertial force, an electrical force, a magnetic force, and an electromagnetic force.

5. The apparatus of claim 1, wherein normal statistical behavior is determined in part by statistics selected from the group consisting of: Maxwell-Boltzmann statistics, Fermi-Dirac statistics, and Bose-Einstein statistics.

6. The apparatus of claim 1, wherein the spatially varying potential field has a second spatial or temporal gradient that is immediately proximate to the spatial or temporal gradient that is sufficiently strong, and wherein a magnitude of the second spatial or temporal gradient is different from a magnitude of the spatial or temporal gradient that is sufficiently strong.

7. The apparatus of claim 6, wherein for a dynamic boundary condition, there is a net flow of objects of interest through the second spatial or temporal gradient and through the spatial or temporal gradient that is sufficiently strong.

8. The apparatus of claim 6, wherein for a static boundary condition, there is a net change in concentration or density of objects of interest on one side of the second spatial or temporal gradient and the spatial or temporal gradient that is sufficiently strong, compared to another side.

9. The apparatus of claim 6, wherein for a static boundary condition, there is a net change in temperature of objects of interest on one side of the second spatial or temporal gradient and the spatial or temporal gradient that is sufficiently strong, compared to another side.

10. The apparatus of claim 6, wherein for a static boundary condition, there is a net change in pressure of objects of interest on one side of the second spatial or temporal gradient and the spatial or temporal gradient that is sufficiently strong, compared to another side.

11. The apparatus of claim 1, wherein the objects of interest carry an element taken from the group consisting of: an induced or permanent electric dipole, an induced or permanent magnetic dipole, and an induced or permanent electric charge.

12. The apparatus of claim 1, wherein the BFGA comprises charges embedded in insulating material.

13. The apparatus of claim 1, wherein the medium comprises a conducting or semiconducting material.

14. The apparatus of claim 1, wherein the body force applied by the BFGA is substantially uniform in direction and magnitude in space, and wherein an asymmetric spatial gradient experienced by the objects of interests is provided by an asymmetric shape of a channel or pipe through the spatially varying potential field.

15. The apparatus of claim 1, wherein the filtration apparatus also comprises at least one channel through which objects of interest can diffuse and within which the objects of interest can be subjected to a spatially or temporally varying potential field.

16. A system comprising:
a first filtration apparatus, wherein the first filtration apparatus includes a first Body Force Generating Apparatus (BFGA); and
a second filtration apparatus, wherein the second filtration apparatus includes a second BFGA, wherein the first BFGA and the second BFGA apply a body force per unit mass on objects of interest in a medium, wherein a spatially varying potential field generated by the first BFGA and the second BFGA causes the objects of interest to have spatially varying potential energy, and wherein a spatial or temporal gradient of the spatially varying potential field is sufficiently strong at at least one location in space or at at least one instant in time such that the objects of interest experience a departure from normal statistical behavior within the spatially varying potential field.

17. The system of claim 16, wherein the first filtration apparatus and the second filtration apparatus are connected in series such that objects of interest can diffuse through the first filtration apparatus and the second filtration apparatus sequentially.

18. The system of claim 16, wherein the first filtration apparatus and the second filtration apparatus are arranged in parallel to each other.

19. A method comprising:
providing a Body Force Generating Apparatus (BFGA) that applies a body force per unit mass on objects of interest in a medium, wherein a spatially varying potential field generated by the BFGA causes the objects of interest to have spatially varying potential energy, and wherein a spatial or temporal gradient of the spatially varying potential field is sufficiently strong at at least one location in space or at at least one instant in time such that the objects of interest experience a departure from normal statistical behavior within the spatially varying potential field.

20. The method of claim 19, wherein the spatial or temporal gradient is larger than a ratio of 0.1% of an average energy of one of the objects of interest over the length of 1000 mean free paths, or larger than 1000 mean free times of one of the objects of interest adjacent to the spatial or temporal gradient.
